(19) United States
(12) Patent Application Publication
(10) Pub. No.: US 2024/0413554 A1
(43) Pub. Date: Dec. 12, 2024

(54) HIGH SPEED, HIGH PERFORMANCE CABLE CONNECTOR

(71) Applicant: Amphenol Commercial Products (Chengdu) Co., Ltd., Chengdu (CN)

(72) Inventors: Nan Qiu, Chendgu (CN); Tao Zeng, Chengdu (CN); Yaohua Hou, Chengdu (CN)

(73) Assignee: Amphenol Commercial Products (Chengdu) Co., Ltd., Chengdu (CN)

(21) Appl. No.: 18/810,653

(22) Filed: Aug. 21, 2024

(30) Foreign Application Priority Data
Jan. 23, 2009 (CN) 202311129047.3
Sep. 1, 2023 (CN) 202322372777.8

(51) Int. Cl. H01R 12/75; H01R 12/71; H01R 13/6466; H01R 13/66

(52) U.S. Cl. CPC H01R 12/75; H01R 12/716; H01R 13/6466; H01R 13/6658

(57) ABSTRACT

A high-speed, high-performance cable connector is provided. The connector includes a housing having one or more slots configured for receiving an add-in card, and one or more subassemblies held by the housing. Each subassembly includes conductive elements held by a subassembly housing in a row. Each conductive element may include a mating end for contacting an add-in card and a tail end for a cable wire to be attached thereon. The conductive elements include first-type conductors for signals and second-type conductors for ground signals. Each first-type conductor may be shaped between a first segment comprising the mating end and a second segment comprising the tail end to receive a capacitor to couple the first and second segments. Techniques described herein can reduce crosstalks and insertion loss, and therefore improve signal integrity at high frequencies and enable transmitting high-speed signals to cables directly attached to connector conductive elements.

### CROSS-REFERENCE TO RELATED APPLICATIONS

This application claims priority to and the benefit of Chinese Patent Application No. 202322372777.8, filed on Sep. 1, 2023. This application also claims priority to and the benefit of Chinese Patent Application No. 202311129047.3, filed on Sep. 1, 2023. The contents of these applications are incorporated herein by reference in their entirety.

### TECHNICAL FIELD

This patent application relates generally to interconnection systems, such as those including electrical connectors, used to interconnect electronic assemblies.

### BACKGROUND

Electrical connectors are used in many electronic systems. It is generally easier and more cost effective to manufacture a system as separate electronic subassemblies, such as printed circuit boards (PCBs), which may be joined together with electrical connectors. Having separable connectors enables components of the electronic system manufactured by different manufacturers to be readily assembled. Separable connectors also enable components to be readily replaced after the system is assembled, either to replace defective components or to upgrade the system with higher performance components.

A known arrangement for joining several printed circuit boards is to have one printed circuit board serve as a backplane. A known backplane is a PCB onto which many connectors may be mounted. Conducting traces in the backplane may be electrically connected to signal conductors in the connectors so that signals may be routed between the connectors. Other printed circuit boards, called “daughterboards” or “daughtercards” may be connected through the backplane. For example, daughtercards may also have connectors mounted thereon. The connectors mounted on a daughtercard may be plugged into the connectors mounted on the backplane. In this way, signals may be routed among daughtercards through the connectors and the backplane. The daughtercards may plug into the backplane at a right angle. The connectors used for these applications may therefore include a right angle bend and are often called “right angle connectors.”

Connectors may also be used in other configurations for interconnecting printed circuit boards. Sometimes, one or more printed circuit boards may be connected to another printed circuit board, called a “motherboard,” that is both populated with electronic components and interconnects the daughterboards. In such a configuration, the printed circuit boards connected to the motherboard may be called daughterboards. The daughterboards are often smaller than the motherboard and may sometimes be aligned parallel to the motherboard. Connectors used for this configuration are often called “stacking connectors” or “mezzanine connectors.” In other systems, the daughterboards may be perpendicular to the motherboard.

For example, this configuration is often used in computers in which the motherboard might have a processor and a bus configured to pass data between the processor and peripherals, such as a graphics processor or memory. Connectors may be mounted to the motherboard and connected to the bus. The peripherals may be implemented on daughtercards with connectors that mate with the connectors on the bus such that separately manufactured peripherals may be readily integrated into a computer made with the motherboard.

In some systems, connections between electronic assemblies may be made through cables. The cables may be terminated to a printed circuit board, which may be connected to a card edge connector. In this way, the printed circuit board can incorporate passive components to optimize system performances.

To enhance the availability of peripherals, the bus and the connectors used to physically connect peripherals via the bus may be standardized. In this way, there may be a large number of peripherals available from a multitude of manufacturers. All of those products, so long as they are compliant with the standard, may be used in a computer that has a bus compliant with the standard. Examples of such standards include serial ATA (SATA), serial attached SCSI (SAS), peripheral component interconnect express (PCIe), or SFF-8639, which are commonly used in computers. The standards have gone through multiple revisions, adapting to the higher performance expected from computers over time.

### BRIEF SUMMARY

Aspects of the present disclosure relates to high speed, high performance cable connectors.

Some embodiments relate to a connector subassembly for a connector configured for direct attachment to a cable. The connector subassembly may comprise a subassembly housing comprising a first side, a second side opposite the first side, and at least one aperture; a plurality of conductive elements held by the subassembly housing in a row, each of the plurality of conductive elements comprising a mating end extending out of the first side of the subassembly housing, and a tail end extending out of the second side of the subassembly housing and configured for direct attachment to a conductor of a cable, the plurality of conductive elements comprising: a first subset, each conductive element in the first subset comprising an intermediate portion exposed in an aperture of the least one aperture, and a second subset; and a plurality of capacitors, each of the plurality of capacitors electrically coupled to a conductive element in the first subset within an aperture of the at least one aperture.

Optionally, the intermediate portion of each conductive element in the first subset comprises a break; and each of the plurality of capacitors is disposed at the break of the intermediate portion of a respective conductive element in the first subset so as to couple the mating end and tail end of the respective conductive element in the first subset.

Optionally, the connector subassembly comprises a plurality of circuit blocks each connecting two adjacent conductive elements in the first subset, each of the plurality of circuit blocks comprising a respective capacitor of the plurality of capacitors.

Some embodiments relate to a connector configured for mounting to a circuit board. The connector may comprise a subassembly housing comprising a first side and a second side opposite the first side; a plurality of conductive elements held by the subassembly housing in a row, each of the plurality of conductive elements comprising a mating end extending out of a first side of the subassembly housing, and a tail end extending out of the second side of the subassembly housing and configured for direct attachment to a cable that passes through the circuit board, the plurality of conductive elements comprising: a plurality of first-type conductors each comprising an intermediate portion between the respective mating end and tail end, the intermediate portion having a break, and a plurality of second-type conductors each comprising an intermediate portion between the respective mating end and tail end; and a plurality of capacitors each disposed at the break of the intermediate portion of a respective first-type conductor of the plurality of first-type conductors so as to couple the mating end and tail end of the respective first-type conductor.

Optionally, the subassembly housing comprises a plurality of apertures; the breaks of the plurality of first-type conductors are disposed in respective apertures of the plurality of apertures of the subassembly housing; and the connector subassembly comprises an insulative material disposed in the plurality of apertures of the subassembly housing.

Optionally, the insulative material is cured adhesive.

Optionally, each of the plurality of first-type conductors comprises a first segment and a second segment separated by the break; and for each of the plurality of first-type conductors, the connector subassembly comprises a first solder material joining the first segment and a first end of a respective capacitor, and a second solder material joining the second segment and a second end of the respective capacitor.

Optionally, the plurality of first-type conductors are disposed in pairs between second-type conductors of the plurality of second-type conductors.

Optionally, the connector further comprises a plurality of cables each comprising a pair of signal wires attached to a respective pair of first-type conductors, and a reference wire attached to a second-type conductor adjacent the respective pair of first-type conductors.

Optionally, the connector further comprises a third-type conductor disposed adjacent to a second-type conductor of the plurality of second-type conductors; and a circuit block comprising a first end disposed on the second-type conductor adjacent the third-type conductor and a second end disposed on the third-type conductors, the circuit block comprising a capacitor and a resistor connected in series.

Optionally, an end of the capacitor of the circuit block is disposed on the second-type conductor; and an end of the resistor of the circuit block is disposed on the third-type conductor.

Optionally, the third-type conductor is shaped similar to a first-type conductor of the plurality of first-type conductors; the second-type conductor comprises a first tail end and a second tail end; the first tail end is disposed closer to a first-type conductor of the plurality of first-type conductors than the third-type conductor; and the second tail end is disposed between the first tail end and the third-type conductor.

Optionally, for each of the plurality of second-type conductors: the second-type conductor comprises a portion jogging toward an adjacent first-type conductor; and the capacitor disposed on the adjacent first-type conductor is disposed offset from the portion of the second-type conductor.

Some embodiments relate to an electronic system. The electronic system may comprise a circuit board comprising an opening; and an electrical connector comprising: a housing at least partially mounted to the circuit board and comprising a first face with a first slot and a second face facing the circuit board; a plurality of capacitors disposed in the housing; and a plurality of first-type conductors disposed in a row in the housing, each of the plurality of first-type conductors comprising a first segment having a mating end curving into the first slot, and a second segment having a tail end extending out of the housing to the opening of the circuit board, the second segment coupled to the first segment by a respective capacitor of the plurality of capacitors.

Optionally, the plurality of capacitors are aligned in a line.

Optionally, the electrical connector comprises a plurality of second-type conductors disposed in the housing and aligned in the row of first-type conductors, each of the plurality of second-type conductors comprising a mating end curving into the first slot and having a first center-to-center pitch to the mating end of an adjacent first-type conductor, a tail end extending out of the housing and having a second center-to-center pitch to the tail end of the adjacent first-type conductor, the second center-to-center pitch less than the first center-to-center pitch, and an intermediate portion joining the mating end and the first tail end.

Optionally, the electrical connector comprises a third-type conductor disposed adjacent to a second-type conductor of the plurality of second-type conductors; and a circuit block comprising a first end disposed on the second-type conductor adjacent the third-type conductor and a second end disposed on the third-type conductors, the circuit block comprising a capacitor and a resistor connected in series.

Optionally, the circuit block is aligned with the plurality of capacitors.

Optionally, the electrical connector comprises a bottom member attached to the housing, the bottom member comprising a body, a plurality of pillars extending from the body toward the housing, and a plurality of projections extending from the pillars and toward tail ends of the plurality of first-type conductors.

Optionally, the electrical connector comprises a lossy member attached to the bottom member and configured to electrically couple the plurality of second-type conductors.

Optionally, the tail ends of the first-type and second-type conductors are configured for cables to be attached thereon; the housing comprises a second slot separated from the first slot by a rib; and the electrical connector comprises a plurality of fourth-type conductors, each of the plurality of fourth-type conductors comprising a mating end curving into the second slot, a tail end extending out of the housing and mounted to the circuit board.

Some embodiments relate to a method of manufacturing a connector subassembly. The method may comprise providing a plurality of conductive elements held together by a stripe; forming a break in each of a plurality of selected ones of the plurality of conductive elements such that each of the plurality of selected conductive elements comprises a first segment and a second segment separated by the break; and for each of the plurality of selected conductive elements, attaching opposite ends of a capacitor to the first and second segments of the conductive element, respectively.

Optionally, the method comprises molding a subassembly housing over the plurality of conductive elements, the subassembly housing comprising a plurality of apertures such that the breaks of the plurality of selected conductive elements are formed in respective apertures of the plurality of apertures; and filling the plurality of apertures of the subassembly housing with an insulative material so as to seal the plurality of capacitors and portions of the plurality of selected conductive elements therein.

Some embodiments relate to a subassembly of an electrical connector. The subassembly may comprise a subassembly housing; and a row of conductors held by the subassembly housing and spaced from each other in a longitudinal direction of the electrical connector, each conductor in its longitudinal direction comprising a mating end, an opposite tail end, and an intermediate portion between the mating end and the tail end, each conductor at its intermediate portion being held by the subassembly housing, the row of the conductors comprising at least a pair of first-type conductors for transmitting a differential signal, wherein the intermediate portion of each first-type conductor comprises a first segment and a second segment which are spaced from each other in the longitudinal direction of the conductor, and the first segment and the second segment are connected to each other by an AC capacitor embedded in the subassembly housing.

Optionally, a distance between the first and second segments mainly depends on the AC capacitor's size.

Optionally, the subassembly housing comprises an enclosing region including an aperture formed in the subassembly housing, in which aperture the AC capacitor is accommodated, and an insulation enclosing material is filled in the aperture.

Optionally, the AC capacitor is attached between the first and second segments.

Optionally, the row of conductors also comprise at least a pair of second-type conductors, two second-type conductors of which are located at both sides of the pair of first-type conductors in the longitudinal direction of the electrical connector respectively and are configured to provide reference or return path for the pair of first-type conductors.

Optionally, the row of conductors also comprise a third-type conductor for transmitting a sideband signal, the third-type conductor may be connected to an adjacent second-type conductor by an RC circuit block embedded in the subassembly housing, and the RC circuit block comprises a resistor and an AC capacitor in series connected with each other.

Optionally, the subassembly housing comprises an enclosing region including an aperture formed in the subassembly housing, in which the RC circuit block may be accommodated. The aperture may be filled with an insulation enclosing material.

Optionally, the RC circuit block is attached between a respective second-type conductor and a respective third-type conductor.

Optionally, the intermediate portion of each conductor of the first-type conductor, the second-type conductor and the third-type conductor comprises a first surface and a second surface on opposite sides, and the AC capacitor of the first-type conductor is located on only one of the first and second surfaces.

Optionally, the intermediate portion of each conductor of the first-type conductor, the second-type conductor and the third-type conductor comprises a first surface and a second surface on opposite sides, and wherein a pair of AC capacitors in a pair of first-type conductors are located on the first surface and the second surface respectively; or one pair of AC capacitors in two pairs of first-type conductors are located on the first surface, and the other pair of AC capacitors are located on the second surface; or the RC circuit block between the second-type conductor and the third-type conductor and the AC capacitor of the first-type conductor are located on the same surface or different surfaces.

Optionally, for each of the first-type conductor, the second-type conductor and the third-type conductor: the tail end comprises a third surface and a four surface on opposite sides; the third surface of the tail end extends from the first surface of the respective intermediate portion; and the four surface of the tail end is offset from the second surface of the intermediate portion.

Optionally, the mating end of each conductor of the first-type conductor, the second-type conductor and the third-type conductor comprises a curved mating contact portion having a width measured in the longitudinal direction of the electrical connector, and the intermediate portion of the same conductor has a width measured in the longitudinal direction which is greater than the width of the mating contact portion.

Optionally, the intermediate portion of each first-type conductor or each third-type conductor includes a surface slanted toward an adjacent second-type conductor, and the intermediate portion of each first-type conductor or each third-type conductor includes a portion bending toward an adjacent second-type conductor.

Optionally, the tail end of a conductor is configured to be connected to a cable.

Optionally, the distance between the first segment and the second segment is 0.25 mm.

Some embodiments relate to a subassembly of an electrical connector. The subassembly may comprise a subassembly housing; and a row of conductors held by the subassembly housing and spaced from each other in a longitudinal direction of the electrical connector, each conductor in its longitudinal direction comprising a mating end, an opposite tail end, and an intermediate portion between the mating end and the tail end, each conductor at its intermediate portion being held by the subassembly housing, the row of conductors comprise at least a pair of first-type conductors for transmitting a differential signal, at least a pair of second-type conductors, and a third-type conductor for transmitting a sideband signal, two second-type conductors of the at least a pair of second-type conductors being at both sides of the pair of first-type conductors in the longitudinal direction of the electrical connector respectively and being configured to provide reference or return path for the pair of first-type conductors, wherein the third-type conductor is connected to an adjacent second-type conductor of the second-type conductors by an RC circuit block embedded in the subassembly housing, and the RC circuit block comprises a resistor and an AC capacitor in series connected with each other.

Optionally, the subassembly housing comprises an enclosing region including a slot formed in the subassembly housing, in which aperture the RC circuit block is accommodated, and an insulation enclosing material is filled in the aperture.

Optionally, the RC circuit block is attached between a respective second-type conductor and a respective third-type conductor.

Optionally, the intermediate portion of each conductor of the first-type conductor, the second-type conductor and the third-type conductor comprises a first surface and a second surface on opposite sides, and the RC circuit block is located on only one of the first and second surfaces.

Optionally, for each of the first-type conductor, the second-type conductor and the third-type conductor: the tail end comprises a third surface and a four surface on opposite sides; the third surface of the tail end extends from the first surface of the respective intermediate portion; and the four surface of the tail end is offset from the second surface of the intermediate portion.

Optionally, the mating end of each conductor of the first-type conductor, the second-type conductor and the third-type conductor comprises a curved mating contact portion having a width measured in the longitudinal direction of the electrical connector, and the intermediate portion of the same conductor has a width measured in the longitudinal direction which is greater than the width of the mating contact portion.

Optionally, the intermediate portion of each first-type conductor or each third-type conductor includes a surface slanted toward an adjacent second-type conductor, and the intermediate portion of each first-type conductor or each third-type conductor includes a portion bending toward an adjacent second-type conductor.

Optionally, the tail end of a conductor is configured to be connected to a cable.

Some embodiments relate to an electrical connector. The electrical connector may comprise a housing comprising a first portion having a first slot, and a second portion separated from the first portion by a rib and having a second slot; a plurality of first conductors in the first portion of the housing, each of the plurality of first conductors comprising a mating end comprising a mating contact portion curving into the first slot, and a tail end extending out of the first portion of the housing and configured to mount to a printed circuit board; and a plurality of second conductors in the second portion of the housing, each of the plurality of second conductors comprising a mating end comprising a mating contact portion curving into the second slot, a tail end extending out of the second portion of the housing, and an intermediate portion joining the mating end and the tail end, the tail end being thinner than the intermediate portion and configured for a cable to be attached to the tail end, the plurality of second conductors comprise at least a pair of first-type second conductors for transmitting a differential signal, wherein the intermediate portion of each first-type second conductor comprises a first segment and a second segment which are spaced from each other in a longitudinal direction of the conductor, and the first segment and the second segment are connected to each other by an AC capacitor.

Optionally, a distance between the first and second segments mainly depends on the AC capacitor's size.

Optionally, the AC capacitor is attached between the first and second segments.

Optionally, the plurality of second conductors also comprise at least a pair of second-type second conductors, two second-type second conductors of which are located at both sides of the pair of first-type second conductors in the longitudinal direction of the electrical connector respectively and are configured to provide reference or return path for the pair of first-type second conductors.

Optionally, the plurality of second conductors also comprise a third-type second conductor for transmitting a sideband signal, the third-type second conductor is connected to an adjacent second-type second conductor by an RC circuit block, and the RC circuit block comprises a resistor and an AC capacitor in series connected with each other.

Optionally, the RC circuit block is attached between a respective second-type second conductor and a respective third-type second conductor.

Optionally, the intermediate portion of each second conductor of the first-type second conductor, the second-type second conductor and the third-type second conductor comprises a first surface and a second surface on opposite sides, the AC capacitor of the first-type second conductor is located on only one of the first surface and the second surface.

Optionally, the intermediate portion of each second conductor of the first-type second conductor, the second-type second conductor and the third-type second conductor comprises a first surface and a second surface on opposite sides, and wherein a pair of AC capacitors in a pair of first-type second conductors are located on the first surface and the second surface respectively; or one pair of AC capacitors in two pairs of first-type second conductors are located on the first surface, and the other pair of AC capacitors are located on the second surface; or the RC circuit block between the second-type second conductor and the third-type second conductor and the AC capacitor of the first-type second conductor are located on the same surface or different surfaces.

Optionally, for each second conductor of the first-type second conductor, the second-type second conductor and the third-type second conductor: the tail end comprises a third surface and a four surface on opposite sides; the third surface of the tail end extends from the first surface of the respective intermediate portion; and the four surface of the tail end is offset from the second surface of the intermediate portion.

Optionally, the intermediate portion of each first-type or third-type second conductor comprises a surface slanted toward an adjacent second-type second conductor, and the intermediate portion of each first-type or third-type conductor includes a portion bending toward an adjacent second-type second conductor.

Optionally, the electrical connector comprises a subassembly including a subassembly housing, and the second conductors are spaced from each other and held by the subassembly housing in rows in the longitudinal direction of the electrical connector.

Optionally, the AC capacitor by which the first segment and the second segment are connected to each other is embedded in the subassembly housing.

Optionally, the subassembly housing comprises an enclosing region including a slot formed in the subassembly housing, in which aperture the AC capacitor is accommodated, and an insulation enclosing material is filled in the aperture.

Optionally, the RC circuit block by which the third-type second connector and the second-type second connector are connected to each other is embedded in the subassembly housing.

Optionally, the subassembly housing comprises an enclosing region including an aperture formed in the subassembly housing, in which aperture the RC circuit block is accommodated, and an insulation enclosing material is filled in the aperture.

Optionally, the mating contact portion of the plurality of the first conductors has a first width in the longitudinal direction of the electrical connector, the mating contact portion of the plurality of the second conductors has a second width in the longitudinal direction, and the first width is greater than the second width.

Optionally, the intermediate portion of the plurality of the first conductors has a third width in the longitudinal direction, and the third width is greater than the first width.

Optionally, the intermediate portion of the plurality of the second conductors has a fourth width in the longitudinal direction, and the fourth width is greater than the second width.

Optionally, the first portion of the housing comprises a plurality of first channels each configured to hold one of the plurality of first conductors, and a plurality of first separators at least partially dividing the plurality of first channels; each of the plurality of first separators comprises one or more slots; each of the plurality of first conductors comprises a wider portion adjacent the tail end; and the wider portions extend into the slots of the plurality of first separators.

Optionally, the second portion of the housing comprises a plurality of second channels each configured to hold one of the plurality of second conductors, and a plurality of second separators at least partially dividing the plurality of second channels; and the subassembly housing is disposed between the plurality of second separators and a wall of the housing.

Optionally, the plurality of first conductors comprise a plurality of first-type first conductors and a plurality of second-type first conductors; the intermediate portion of each of the plurality of second-type first conductors comprises a portion bending toward the first slot; and the plurality first-type first conductors and the plurality of second-type first conductors alternate in a longitudinal direction perpendicular to the mating direction.

Optionally, the mating ends of the plurality of first conductors are aligned in a first line parallel to the longitudinal direction; the tail ends of the plurality of first-type first conductors are aligned in a second line parallel to the first line; and the tail ends of the plurality of second-type first conductors are aligned in a third line parallel to the first line and offset from the second line in a transverse direction perpendicular to the mating direction and the longitudinal direction.

Optionally, the mating end of each of the plurality of first conductors comprises a tip portion disposed on a shelf of the first portion of the housing.

Optionally, the mating end of each of the plurality of first conductors comprises a tip portion disposed on a shelf of the second portion of the housing; and the shelf of the second portion of the housing is below the shelf of the first portion of the housing in the mating direction.

Optionally, the tip portion of each of the plurality of first conductors is thinner than the respective mating contact portion.

Optionally, the intermediate portion of each of the plurality of second-type second conductors comprises a projection protruding toward the second slot.

Optionally, the distance between the first segment and the second segment is 0.25 mm.

Some embodiments relate to an electrical connector. The electrical connector may comprise a housing comprising a first portion having a first slot, a second portion separated from the first portion by a rib and having a second slot, and a bottom member attached to the second portion; a plurality of first conductors held by the first portion of the housing, each of the plurality of first conductors comprising a mating end comprising a mating contact portion curving into the first slot, and a tail end extending out of the first portion of the housing and beyond the bottom member in a mating direction; and a plurality of second conductors held by the second portion of the housing, each of the plurality of second conductors comprising a mating end comprising a mating contact portion curving into the second slot, and a tail end extending out of the second portion of the housing and within the bottom member in the mating direction, wherein: the plurality of first conductors are configured to mount to a printed circuit board; and the plurality of second conductors are configured to mount with cables, the plurality of second conductors comprise at least a pair of first-type second conductors for transmitting a differential signal, wherein an intermediate portion of each first-type second conductor comprises a first segment and a second segment which are spaced from each other in a longitudinal direction of the conductor, and the first segment and the second segment are connected to each other by an AC capacitor.

Optionally, a distance between the first and second segments mainly depends on the AC capacitor's size.

Optionally, the AC capacitor is attached between the first and second segments.

Optionally, the plurality of second conductors also comprise at least a pair of second-type second conductors, two second-type second conductors of which are located at both sides of the pair of first-type second conductors in the longitudinal direction of the electrical connector respectively and are configured to provide reference or return path for the pair of first-type second conductors.

Optionally, the plurality of second conductors also comprise a third-type second conductor for transmitting a sideband signal, the third-type second conductor is connected to an adjacent second-type second conductor by an RC circuit block, and the RC circuit block comprises a resistor and an AC capacitor in series connected with each other.

Optionally, the RC circuit block is attached between a respective second-type second conductor and a respective third-type second conductor.

Optionally, the electrical connector comprises a subassembly including a subassembly housing, and the second conductors are held by the subassembly housing in rows in a longitudinal direction of the electrical connector.

Optionally, the AC capacitor by which the first segment and the second segment are connected to each other is embedded in the subassembly housing.

Optionally, the subassembly housing comprises an enclosing region including an aperture formed in the subassembly housing, in which aperture the AC capacitor is accommodated, and an insulation enclosing material is filled in the aperture.

Optionally, the RC circuit block by which the third-type second connector and the second-type second connector are connected to each other is embedded in the subassembly housing.

Optionally, the subassembly housing comprises an enclosing region including an aperture formed in the subassembly housing, in which aperture the RC circuit block is accommodated, and an insulation enclosing material is filled in the aperture.

Optionally, the subassembly housing comprises a plurality of projections disposed in matching openings of the second portion of the housing, the intermediate portion of each of the plurality of second-type second conductors comprises a projection protruding toward the second slot; and the subassembly housing comprises a plurality of openings disposed corresponding to the projections of the plurality of second-type second conductors.

Optionally, the bottom member comprises a body, a plurality of pillars extending from the body toward the second portion of the housing, and a plurality of projections extending from the pillars and toward the tail ends of the plurality of second conductors.

Optionally, a portion of the plurality of projections comprises a plurality of recesses; each of the plurality of second conductors comprises a transition region between the intermediate portion and the tail end; the plurality of second conductors comprise a plurality of first-type second conductors and a plurality of second-type second conductors; and the transition regions of the plurality of first-type second conductors are disposed in respective recesses of the plurality of recesses.

Optionally, the housing further comprises a lossy member configured to electrically couple the plurality of second-type second conductors.

Optionally, the lossy member comprises a body, a plurality of first pillars extending from the body toward the second portion of the housing, and a plurality of second pillars extending from the body away from the second portion of the housing and disposed between adjacent pillars of the bottom member.

Optionally, the plurality of second pillars of the lossy member comprise a plurality of recesses; and the transition regions of the plurality of second-type second conductors are disposed in respective recesses of the plurality of recesses of the plurality of second pillars of the lossy member.

Optionally, the plurality of first pillars of the lossy member comprise a plurality of projections protruding toward the plurality of second-type second conductors.

Optionally, for each of the plurality of second-type second conductors: the corresponding recess of the second pillar is offset from the projection of the first pillar in a longitudinal direction perpendicular to the mating direction.

Optionally, the lossy member comprises a plurality of first openings; the bottom member comprises a plurality of second openings stacked below respective ones of the plurality of first openings of the lossy member in the mating direction; and the second portion of the housing comprises a plurality of projections each extending through a first opening of the lossy member and a second opening of the bottom member.

Optionally, a distance between the first segment and the second segment is 0.25 mm.

Some embodiments relate to an electrical connector. The electrical connector may comprise a housing comprising a first portion having a first slot, and a second portion separated from the first portion by a rib and having a second slot; a plurality of first conductors in the first portion of the housing, each of the plurality of first conductors comprising a mating end comprising a mating contact portion curving into the first slot, and a tail end extending out of the first portion of the housing and configured to mount to a printed circuit board; and a plurality of second conductors in the second portion of the housing, each of the plurality of second conductors comprising a mating end comprising a mating contact portion curving into the second slot, a tail end extending out of the second portion of the housing, and an intermediate portion joining the mating end and the tail end, the tail end being thinner than the intermediate portion and configured for a cable to be attached to the tail end, the plurality of second conductors comprise at least a pair of first-type second conductors for transmitting a differential signal, at least a pair of second-type second conductors, and a third-type second conductor for transmitting a sideband signal, two second-type second conductors of the at least a pair of second-type second conductors being located at both sides of the pair of first-type second conductors in a longitudinal direction of the electrical connector respectively and are configured to provide reference or return path for the pair of first-type second conductors, wherein the third-type second conductor is connected to an adjacent second-type second conductor by an RC circuit block, and the RC circuit block comprises a resistor and an AC capacitor in series connected with each other.

Optionally, the intermediate portion of each second conductor of the first-type second conductor, the second-type second conductor and the third-type second conductor comprises a first surface and a second surface on opposite sides, and the RC circuit block is located on only one of the first surface and the second surface.

Optionally, for each second conductor of the first-type second conductor, the second-type second conductor and the third-type second conductor: the tail end comprises a third surface and a four surface on opposite sides; the third surface of the tail end extends from the first surface of the respective intermediate portion; and the four surface of the tail end is offset from the second surface of the intermediate portion.

Optionally, the mating end of each second conductor of the first-type second conductor, the second-type second conductor and the third-type second conductor comprises a curved mating contact portion having a width measured in the longitudinal direction of the electrical connector, and the intermediate portion of the same second conductor has a width measured in the longitudinal direction which is greater than the width of the mating contact portion.

Optionally, the intermediate portion of each first-type or third-type second conductor includes a surface slanted toward an adjacent second-type conductor, and the intermediate portion of each first-type or each third-type second conductor includes a portion bending toward an adjacent second-type second conductor.

Optionally, the electrical connector comprises a subassembly including a subassembly housing, and the second conductors are spaced from each other and held by the subassembly housing in rows in the longitudinal direction of the electrical connector.

Optionally, the RC circuit block is embedded in the subassembly housing.

Optionally, the subassembly housing comprises an enclosing region including an aperture formed in the subassembly housing, in which aperture the RC circuit block is accommodated, and an insulation enclosing material is filled in the aperture.

Optionally, the RC circuit block is attached between a respective second-type conductor and a respective third-type conductor.

Optionally, the mating contact portion of the plurality of the first conductors has a first width in the longitudinal direction of the electrical connector, the mating contact portion of the plurality of the second conductors has a second width in the longitudinal direction, and the first width is greater than the second width.

Optionally, the intermediate portion of the plurality of the first conductors has a third width in the longitudinal direction, and the third width is greater than the first width.

Optionally, the intermediate portion of the plurality of the second conductors has a fourth width in the longitudinal direction, and the fourth width is greater than the second width.

Optionally, the first portion of the housing comprises a plurality of first channels each configured to hold one of the plurality of first conductors, and a plurality of first separators at least partially dividing the plurality of first channels; each of the plurality of first separators comprises one or more slots; each of the plurality of first conductors comprises a wider portion adjacent the tail end; and the wider portions extend into the slots of the plurality of first separators.

Optionally, the second portion of the housing comprises a plurality of second channels each configured to hold one of the plurality of second conductors, and a plurality of second separators at least partially dividing the plurality of second channels; and the subassembly housing is disposed between the plurality of second separators and a wall of the housing.

Optionally, the plurality of first conductors comprise a plurality of first-type first conductors and a plurality of second-type first conductors; the intermediate portion of each of the plurality of second-type first conductors comprises a portion bending toward the first slot; and the plurality first-type first conductors and the plurality of second-type first conductors alternate in a longitudinal direction perpendicular to the mating direction.

Optionally, the mating ends of the plurality of first conductors are aligned in a first line parallel to the longitudinal direction; the tail ends of the plurality of first-type first conductors are aligned in a second line parallel to the first line; and the tail ends of the plurality of second-type first conductors are aligned in a third line parallel to the first line and offset from the second line in a transverse direction perpendicular to the mating direction and the longitudinal direction.

Optionally, the mating end of each of the plurality of first conductors comprises a tip portion disposed on a shelf of the first portion of the housing.

Optionally, the mating end of each of the plurality of first conductors comprises a tip portion disposed on a shelf of the second portion of the housing; and the shelf of the second portion of the housing is below the shelf of the first portion of the housing in the mating direction.

Optionally, the tip portion of each of the plurality of first conductors is thinner than the respective mating contact portion.

Optionally, the intermediate portion of each of the plurality of second-type second conductors comprises a projection protruding toward the second slot.

Some embodiments relate to an electrical connector. The electrical connector may comprise a housing comprising a first portion having a first slot, a second portion separated from the first portion by a rib and having a second slot, and a bottom member attached to the second portion; a plurality of first conductors held by the first portion of the housing, each of the plurality of first conductors comprising a mating end comprising a mating contact portion curving into the first slot, and a tail end extending out of the first portion of the housing and beyond the bottom member in a mating direction; and a plurality of second conductors held by the second portion of the housing, each of the plurality of second conductors comprising a mating end comprising a mating contact portion curving into the second slot, and a tail end extending out of the second portion of the housing and within the bottom member in the mating direction, wherein: the plurality of first conductors are configured to mount to a printed circuit board; and the plurality of second conductors are configured to mount with cables; the plurality of second conductors comprise at least a pair of first-type second conductors for transmitting a differential signal, at least a pair of second-type second conductors, and a third-type second conductor for transmitting a sideband signal, two second-type second conductors of the at least a pair of second-type second conductors are located at both sides of the pair of first-type second conductors in a longitudinal direction of the electrical connector respectively and are configured to provide reference or return path for the pair of first-type second conductors, wherein the third-type second conductor is connected to an adjacent second-type second conductor by an RC circuit block, and the RC circuit block comprises a resistor and an AC capacitor in series connected with each other.

Optionally, the intermediate portion of each second conductor of the first-type second conductor, the second-type second conductor and the third-type second conductor comprises a first surface and a second surface on opposite sides, and the RC circuit block is located on only one of the first surface and the second surface.

Optionally, for each second conductor of the first-type second conductor, the second-type second conductor and the third-type second conductor: the tail end comprises a third surface and a four surface on opposite sides; the third surface of the tail end extends from the first surface of the respective intermediate portion; and the four surface of the tail end is offset from the second surface of the intermediate portion.

Optionally, the mating end of each second conductor of the first-type second conductor, the second-type second conductor and the third-type second conductor comprises a curved mating contact portion having a width measured in the longitudinal direction of the electrical connector, and the intermediate portion of the same second conductor has a width measured in the longitudinal direction which is greater than the width of the mating contact portion.

Optionally, the intermediate portion of each first-type or third-type second conductor includes a surface slanted toward an adjacent second-type conductor, and the intermediate portion of each first-type or each third-type second conductor includes a portion bending toward an adjacent second-type second conductor.

Optionally, the electrical connector comprises a subassembly including a subassembly housing, and the second conductors are spaced from each other and held by the subassembly housing in rows in the longitudinal direction of the electrical connector.

Optionally, the RC circuit block is embedded in the subassembly housing.

Optionally, the subassembly housing comprises an enclosing region including an aperture formed in the subassembly housing, in which aperture the RC circuit block is accommodated, and an insulation enclosing material is filled in the aperture.

Optionally, the RC circuit block is attached between a respective second-type conductor and a respective third-type conductor.

Optionally, the bottom member comprises a body, a plurality of pillars extending from the body toward the second portion of the housing, and a plurality of projections extending from the pillars and toward the tail ends of the plurality of second conductors.

Optionally, a portion of the plurality of projections comprises a plurality of recesses; each of the plurality of second conductors comprises a transition region between the intermediate portion and the tail end; the plurality of second conductors comprise a plurality of first-type second conductors and a plurality of second-type second conductors; and the transition regions of the plurality of first-type second conductors are disposed in respective recesses of the plurality of recesses.

Optionally, the housing further comprises a lossy member configured to electrically couple the plurality of second-type second conductors.

Optionally, the lossy member comprises a body, a plurality of first pillars extending from the body toward the second portion of the housing, and a plurality of second pillars extending from the body away from the second portion of the housing and disposed between adjacent pillars of the bottom member.

Optionally, the plurality of second pillars of the lossy member comprise a plurality of recesses; and the transition regions of the plurality of second-type second conductors are disposed in respective recesses of the plurality of recesses of the plurality of second pillars of the lossy member.

Optionally, the plurality of first pillars of the lossy member comprise a plurality of projections protruding toward the plurality of second-type second conductors.

Optionally, for each of the plurality of second-type second conductors: the corresponding recess of the second pillar is offset from the projection of the first pillar in a longitudinal direction perpendicular to the mating direction.

Optionally, the lossy member comprises a plurality of first openings; the bottom member comprises a plurality of second openings stacked below respective ones of the plurality of first openings of the lossy member in the mating direction; and the second portion of the housing comprises a plurality of projections each extending through a first opening of the lossy member and a second opening of the bottom member.

Some embodiments relate to an electronic system. The electronic system may comprise a printed circuit board; an electrical connector described herein; and a cable, wherein the printed circuit board is connected to a first conductor of the electrical connector, and the cable is connected to a second conductor of the electrical connector.

These techniques may be used alone or in any suitable combination. The foregoing summary is provided by way of illustration and is not intended to be limiting.

### BRIEF DESCRIPTION OF THE DRAWINGS

The accompanying drawings are not intended to be drawn to scale. In the drawings, identical or nearly identical components that are illustrated in various figures may be represented by a like numeral. For purposes of clarity, not every component may be labeled in every drawing. In the drawings:

FIG. 1A is a top, front perspective view of a portion of an electronic system, illustrating a hybrid card edge connector having power conductors mounted on a printed circuit board, according to some embodiments.

FIG. 1B is a bottom, front perspective view of the electronic system of FIG. 1A.

FIG. 2A is a top, rear perspective view of the hybrid card edge connector of the electronic system of FIG. 1A.

FIG. 2B is a bottom, front perspective view of the hybrid card edge connector of FIG. 2A.

FIG. 2C is a partially exploded perspective view of the hybrid card edge connector of FIG. 2B, with the power conductors, signal conductors, and board lock hidden, showing an example in which an optional lossy member is installed in a bottom member.

FIG. 2CA is an enlarged view of a first portion of the hybrid card edge connector of FIG. 2B, with a few power conductors hidden.

FIG. 2D is a perspective view of the hybrid card edge connector of FIG. 2A, with a housing hidden.

FIG. 2E is a side view of power conductors of the hybrid card edge connector of FIG. 2A.

FIG. 2F is a perspective view of groups of signal conductors of the hybrid card edge connector of FIG. 2A.

FIG. 2G is a perspective view of the hybrid card edge connector of FIG. 2A, with the housing, board lock, power conductors, and some signal conductors hidden.

FIG. 2H is a partially exploded perspective view of the hybrid card edge connector of FIG. 2G, showing the lossy member and bottom member.

FIG. 3A is a front perspective view of a connector subassembly of the hybrid card edge connector of FIG. 2A, according to some embodiments.

FIG. 3B is a back perspective view of the connector subassembly of FIG. 3A.

FIG. 4A is a cross-sectional view of the hybrid card edge connector of FIG. 2A along a line marked “4A-4A” in FIG. 2A, showing power conductors.

FIG. 4B is a cross-sectional view of the hybrid card edge connector of FIG. 2A along a line marked “4B-4B” in FIG. 2A, showing signal conductors.

FIG. 4C is a cross-sectional view of the hybrid card edge connector of FIG. 2A along a line parallel to the line marked “4B-4B” in FIG. 2A, showing a first-type signal conductor and an upper portion of a second-type signal conductor.

FIG. 4D is a cross-sectional view of the hybrid card edge connector of FIG. 2A along another line parallel to the line marked “4B-4B” in FIG. 2A, showing a lower portion of the second-type signal conductor of FIG. 4C.

FIG. 4E is a cross-sectional view of the hybrid card edge connector of FIG. 2A along a separator of channels of the housing illustrated as a line marked “4E-4E” in FIG. 2C.

FIG. 5 is a perspective view of a group of signal conductors of the hybrid card edge connector of FIG. 2A, with a subassembly housing hidden, according to some embodiments.

FIG. 6A is a partial perspective view of a cable connected to signal conductors of the hybrid card edge connector of FIG. 2A.

FIG. 6B is an enlarged perspective view of the cable attachments of FIG. 6A, showing the cable connected to tail ends of the signal conductors, in which the signal conductors comprise a pair of signal conductors for transmission of differential signals and two signal conductors located respective at both sides of the pair of signal conductors and for providing reference or return path for the signals.

FIGS. 7A to 7F are views showing a method of manufacturing the connector subassembly of FIG. 3A, according to some embodiments.

FIG. 8A is a simulated chart showing the differential insertion loss for transmission of differential signals with increasing frequency.

FIG. 8B is a simulated chart showing the differential return loss (cable side) loss for transmission of differential signals with increasing frequency.

FIG. 8C is a simulated chart showing the differential return loss (card side) of signal conductors for transmission of differential signals with increasing frequency.

FIG. 9 is a flow chart schematically illustrating a method of assembling the hybrid card edge connector of FIG. 2A.

### DETAILED DESCRIPTION

The inventors have recognized and appreciated techniques for making connectors that support transmission of high-speed signals between add-in cards and cables with high integrity in compact electronic systems. The inventors have recognized and appreciated that resonances may occur at the direct attachments between conductive elements of a connector and cables. Such resonances can cause crosstalks for differential pairs and some auxiliary signals at high frequencies. While conventional connectors may rely on circuits on a PCB to which the connector is mounted to satisfy some performance requirements, the inventors have recognized and appreciated designs for higher performance that do not require connections between such a PCB and conductive elements of the connector.

According to aspects of the present disclosure, a connector may include a housing having one or more slots configured for receiving an add-in card, and one or more subassemblies held by the housing. Each subassembly may include a subassembly housing with first and second sides opposite to each other and conductive elements held by the subassembly housing in a row. Each conductive element may include a mating end extending out of the first side of the subassembly housing and curving into a slot of the connector housing so as to make contact with contact fingers of an add-in card when the add-in card is inserted into the slot. Each conductive element may include a tail end extending out of the second side of the subassembly housing and configured for a cable wire to be attached thereon. The conductive elements may include first-type conductors configured for high-speed signals and second-type conductors configured for ground signals. It should be appreciated that ground conductors need not to be connected to earth ground, but may carry reference potentials, which may include earth ground, DC voltages or other suitable reference potentials.

Each first-type conductor may include a break between a first segment comprising the mating end and a second segment comprising the tail end. A capacitor may be disposed at the break so as to couple the first and second segments. Such a connector subassembly can reduce crosstalks and insertion loss, and therefore improve signal integrity at high frequencies and enable transmitting high-speed signals to cables directly attached to connector conductive elements.

In some embodiments, a subassembly may include one or more third-type conductors configured for sideband signals. A third-type conductor may be disposed adjacent to a second-type conductor. The subassembly may include a circuit board coupling the second-type and third-type conductors. The circuit board may include a capacitor and a resistor connected in series.

In some embodiments, the subassembly housing may include apertures such that portions of the conductive elements are accessible through the apertures. The breaks of the first-type conductors may be formed in respective apertures. An insulative material (e.g., cured adhesive) may be disposed in the apertures so as to seal the conductive elements and the capacitors and/or circuit blocks attached thereto.

In some embodiments, a connector may have a first portion with conductors configured to carry power and a second portion with conductors configured for high-speed signals. The conductors in the first portion may have tail ends configured for connection to a printed circuit board to which the connector is mounted. The second portion of the connector may be configured to align with an opening through the PCB and high-speed conductors of the second portion may have tail ends configured for termination of cables that pass through the opening in the PCB. The first portion and the second portion may be integrated to collectively provide a mating interface compliant with PCIe or another standard. A connector satisfying the mechanical requirements of the PCIe specification at the performance required for 32 Gbps and 64 Gbps and beyond is used as an example of a connector in which these techniques have been applied. The connector may be also compatible with speed rate lower than 32 Gbps such as PCIe Gen1 to Gen4.

In some embodiments, a connector may have one or more rows of conductors. Some conductors in a row may serve as power conductors, and some conductors may serve as high-speed signal conductors. Optionally, some conductors may serve as low-speed signal conductors. Some of the low-speed signal conductors and/or power conductors may also be designated as grounds, referencing the signals carried on the signal conductors or providing a return path for those signals.

In some embodiments, a connector housing may include a first portion configured for holding power conductors and a second portion configured for holding subassemblies described herein. The first portion and the second portion may be separated from each other by, for example, a rib. A mounting face of the first portion may be disposed beyond a mounting face of the second portion in a mating direction. The housing may include a bottom member disposed at the mounting face of the second portion. The housing may further include a lossy member having a body disposed between the mounting face of the second portion and a body of the bottom member. Such a configuration may enable the power conductors in the first portion to be mounted to a printed circuit board (PCB) and the conductors in the second portion to transmit high-speed signals with high integrity through cables terminated to those conductors.

The first portion and the second portion may include channels configured for holding power conductors and signal conductors, respectively. The first portion may include a bar disposed adjacent a mating face of the connector and configured to serve as a shelf for holding tip portions of the power conductors. The second portion may include a bar disposed adjacent the mating face of the connector and projections extending from the bar and elongated in the mating direction. The projections may be configured to serve as a shelf for holding tip portions of the signal conductors. Such a configuration may enable the power conductors to mate to/demate from an electronic card engaging/disengaging the connector before the signal conductors. Such a configuration may also enable the signal conductors to have shorter tip portions and therefore improved signal integrity.

Each power conductor may include a mating end having a mating contact portion, a tail end opposite the mating end, and an intermediate portion joining the mating end and the tail end. The mating end may have a same width in the longitudinal direction as the intermediate portion, which may provide larger contact area for power transmission to an add-in card. The mating ends for the power conductors in a row may be aligned in a line. In some embodiments, the tail end may be configured to mount to a PCB. The intermediate portion of every other power conductor may include a portion bending toward an adjacent row such that the tail ends of the power conductors in a row may be aligned in two different lines parallel to each other. Such a configuration may enable more power conductors in the connector while requiring no larger mounting area on a PCB than the specification by a standard. In some embodiments, the tail end may be configured to mate with a power adaptor, which may be configured to mount to a PCB. Such a configuration may enable the power conductors to be electrically coupled to the PCB through the power adapter, which may eliminate the need to solder the power conductors on the PCB and therefore facilitate the following maintenance and reduce maintenance costs.

Each signal conductor may include a mating end having a mating contact portion, a tail end configured to mount with cables, and an intermediate portion joining the mating end and the tail end. The mating end may be narrower in the longitudinal direction than the intermediate portion, which may enable larger separations between the mating ends and therefore reduce cross talk at the mating interface. The intermediate portion may include a transition portion such that the tail end is recessed from the intermediate portion, which may provide space for projections of the bottom member or lossy member to protrude in and therefore provide mechanical support to the tail end. The resulting thinner tail end may reduce the impedance impact of the added masses at the cable attachments and therefore reduce impedance imbalance at the mounting interface. The signal conductors can comprise first-type signal conductors and second-type signal conductors. The tail ends of first-type signal conductors may abut the projections of the bottom member and therefore may be electrically isolated from each other. The tail ends of second-type signal conductors may abut projections of the lossy member and therefore may be electrically coupled by the lossy member.

The first-type signal conductors and second-type signal conductors may be arranged in groups. Each group may be configured to be mounted with the wires of one cable. A group may include a pair of first-type signal conductors each configured to transmit a differential signal and a pair of second-type signal conductors configured to provide reference or return paths for the pair of first-type signal conductors carrying the differential signals. The pair of second-type signal conductors maybe disposed on opposite sides of the pair of first-type signal conductors. The intermediate portions of the pair of first-type signal conductors may include surfaces slanted toward each other to improve the coupling between the pair. The intermediate portions of the pair of second-type signal conductors may each include a portion bending toward the pair of first-type signal conductors such that the tail ends of the pair of second-type signal conductors may be disposed closer to the tail ends of the pair of first-type signal conductors. Such a configuration may enable the mating ends of the signal conductors having a first pitch configured for mating with an electronic card and the tail ends of the signal conductors having a second pitch configured for mounting with cables. Such a configuration may compensate for the impedance impact of the added masses at the cable attachments and therefore reduce impedance imbalance. Alternatively or additionally, the first-type signal conductors can be configured to transmit a sideband signal in addition of the differential signal.

The techniques described herein may be used alone or in any suitable combination. The following embodiments show examples of combinations of these techniques.

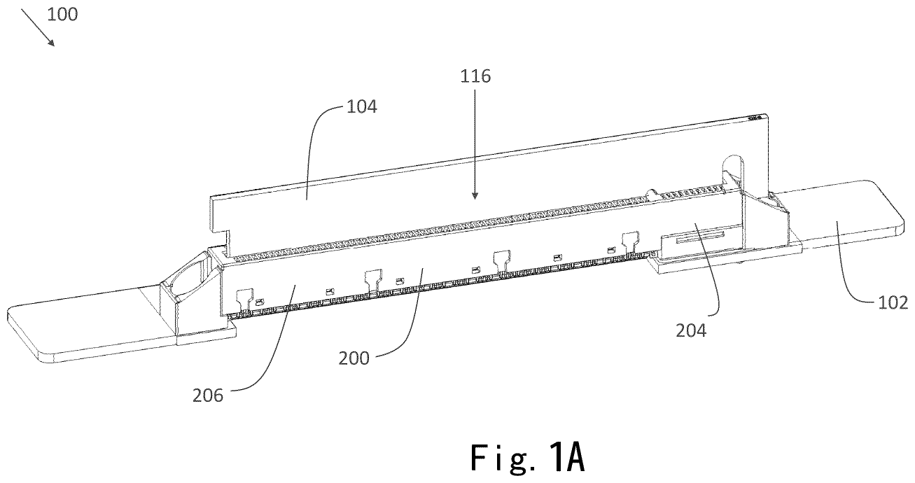

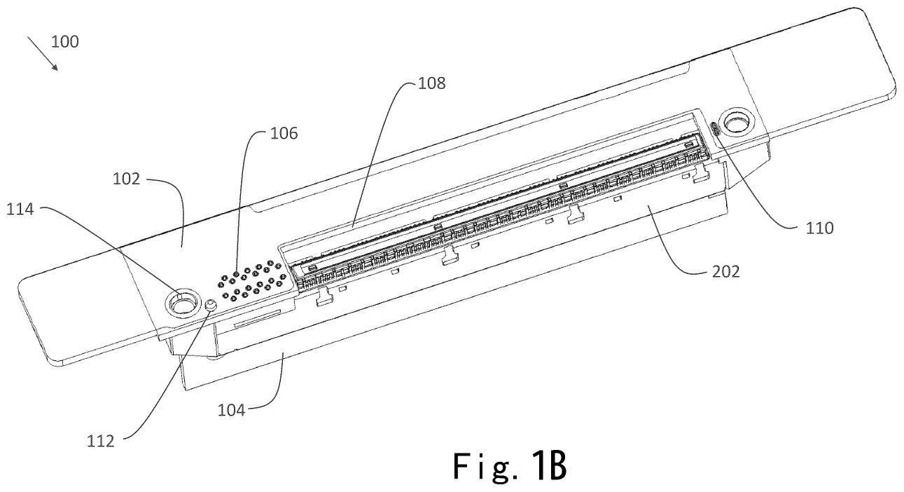

FIGS. 1A-4D are an example of techniques as described herein integrated into a hybrid card edge connector 200 (which may be referred to as an electrical connector 200). Connector 200 may be disposed in an electronic system 100. As illustrated in FIGS. 1A-1B, the electronic system 100 may include PCB 102, onto which the connector 200 may be mounted, and PCB 104, which may have an edge inserted into one or more slots of the connector 200 in a mating direction 116. In the illustrated example, PCB 102 is shown partially cut away, such that only portions of PCB 102 adjacent connector 200 are visible. The cutaway portions of PCB 102 may include other here-not-shown components of the electronic system 100, such as semiconductor components, power regulators or the like. Additionally, for simplicity of illustration, conductive structures within PCB 102 are not expressly illustrated. However, such a PCB may include power planes and/or ground planes, which may be coupled to power conductors within connector 200.

PCB 102 may include contact locations 106 configured for power conductors of the connector 200 to be mounted onto, and a recess 108 or an opening (not shown) for cables mounted onto signal conductors of the connector 200 to pass through such that the cables may be routed to designed locations on PCB 102 and/or another component in the system 100. Since the area of the contact locations 106 may be smaller than the area of the recess 108, PCB 102 may include features for securing a housing 202 of the connector 200 to PCB 102 when the connector 200 is mounted to PCB 102. In the illustrated example, PCB 102 includes a board lock receiver 110 on one side of the recess 108 and configured for receiving a board lock 226 of the connector 200, a guidepost receiver 112 on an opposite side of the recess 108 and configured for receiving a guidepost 224 of the connector 200, a pair of openings 114 on the opposite sides of the recess 108 configured for, for example, screws to pass through.

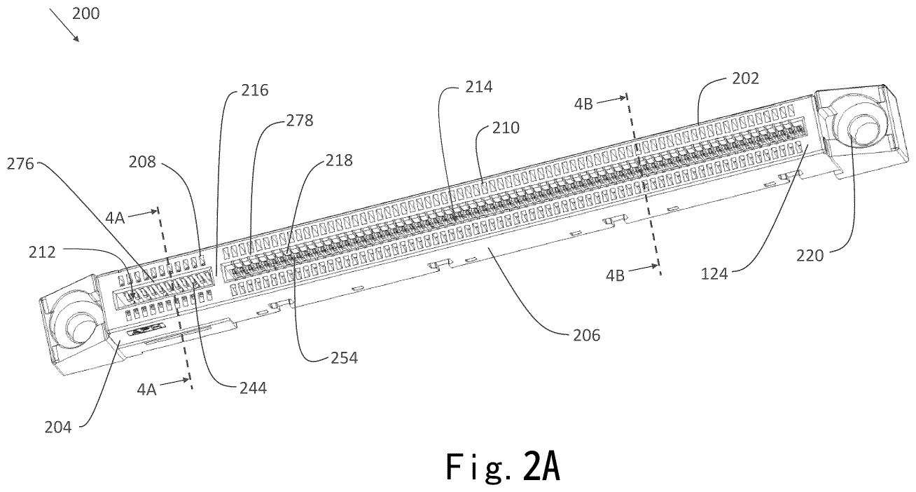

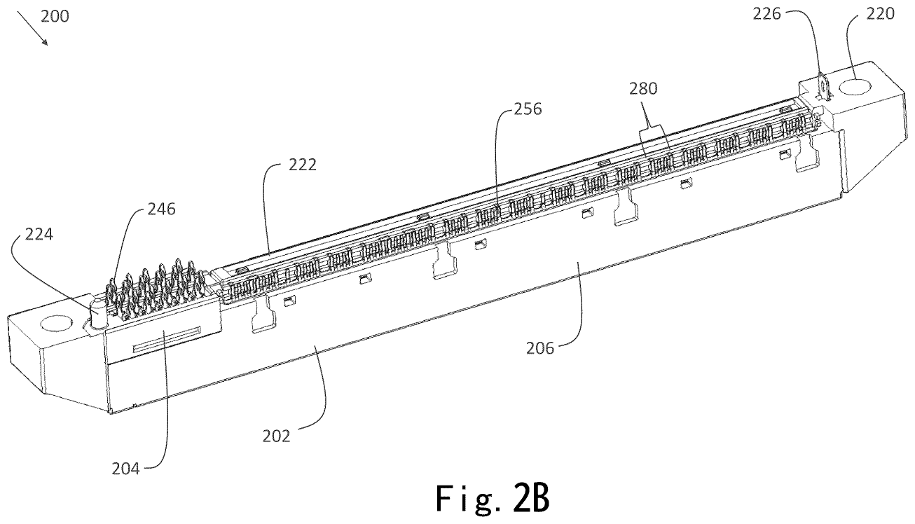

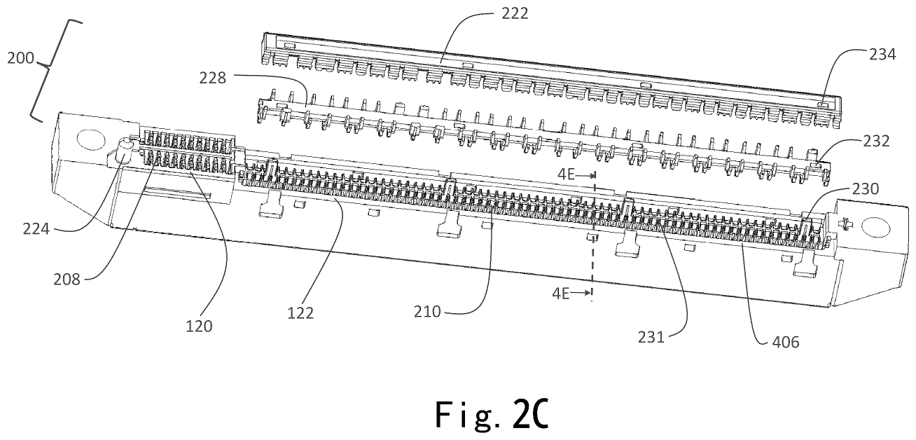

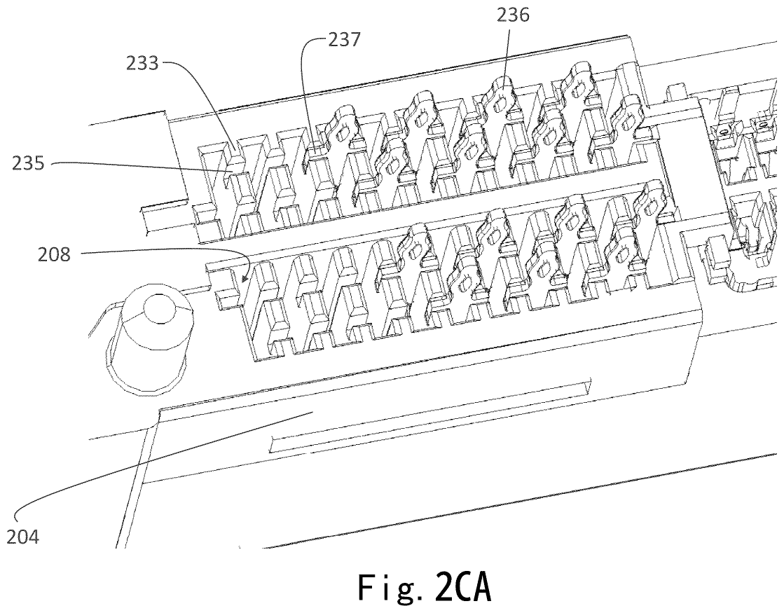

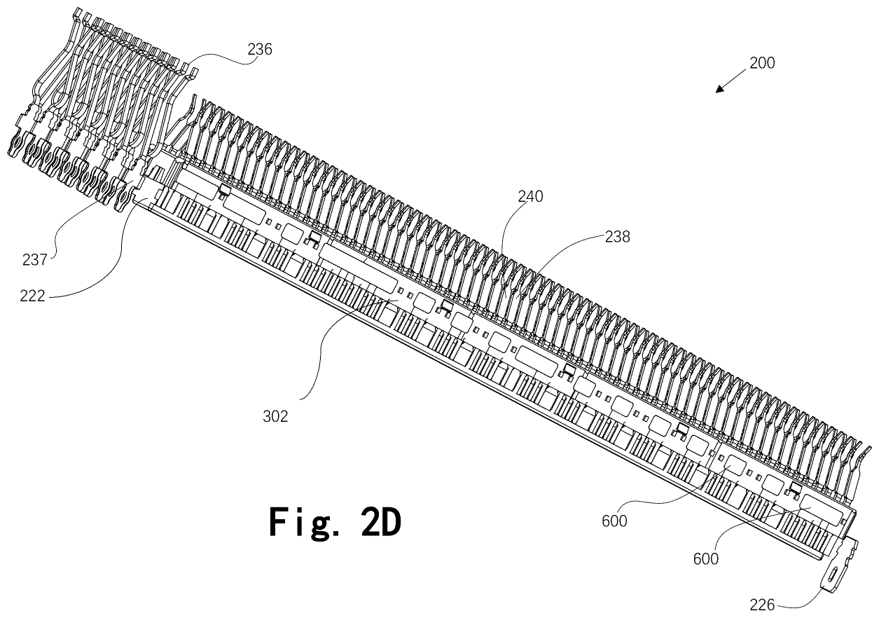

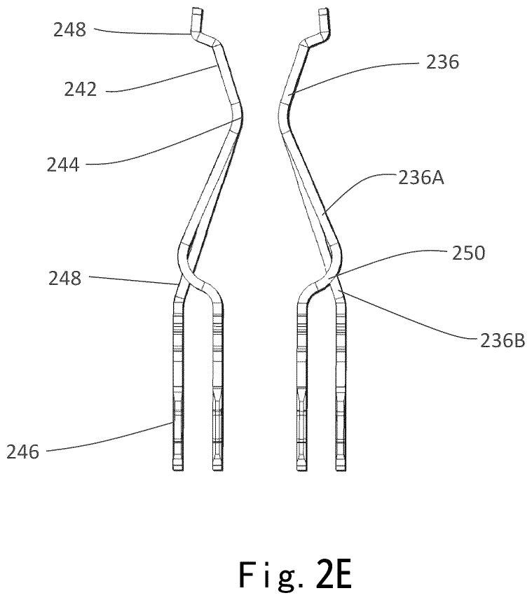

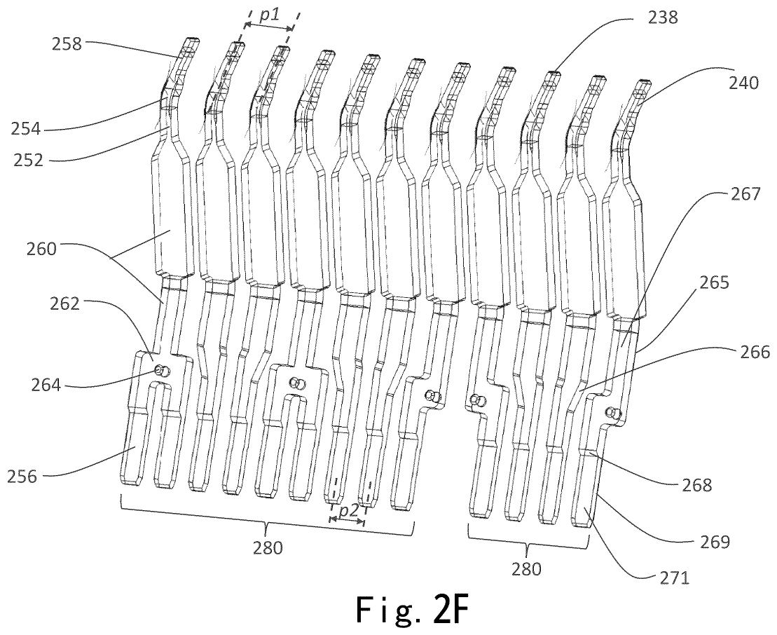

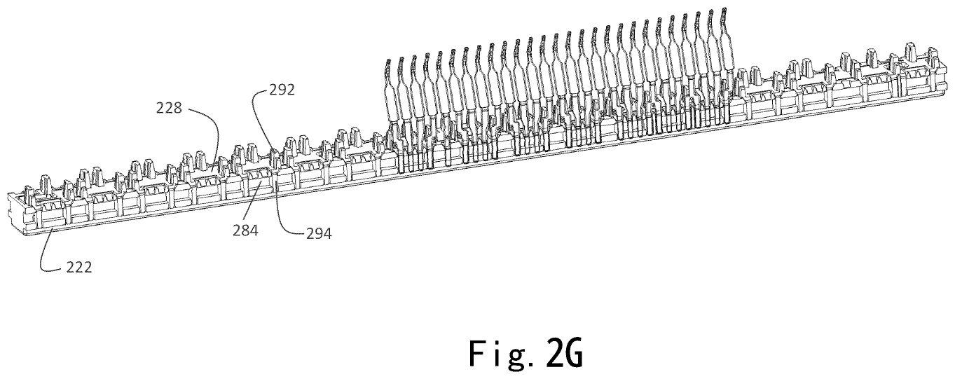

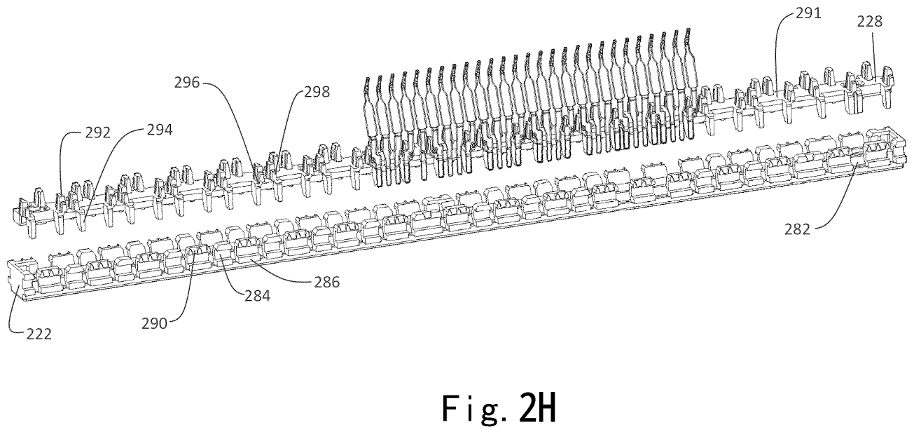

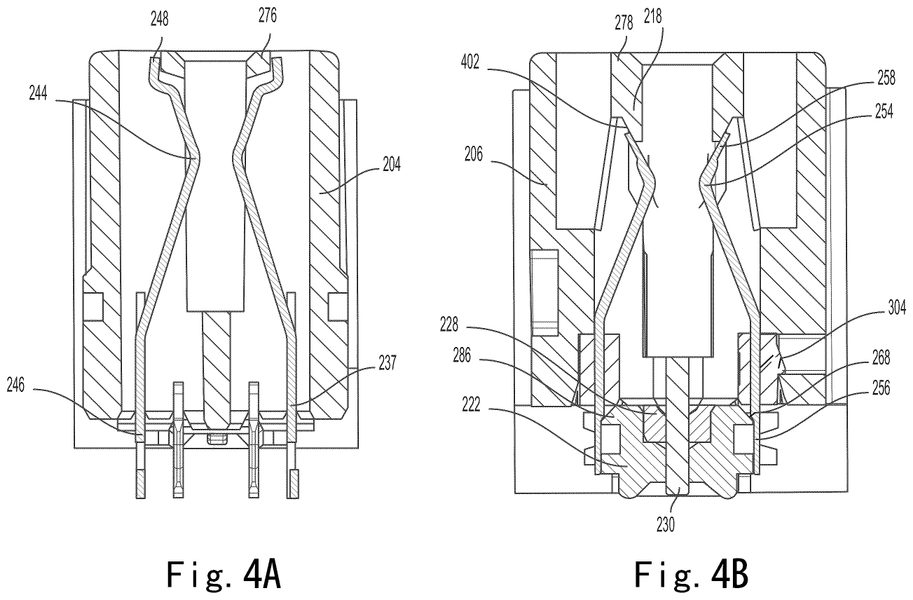

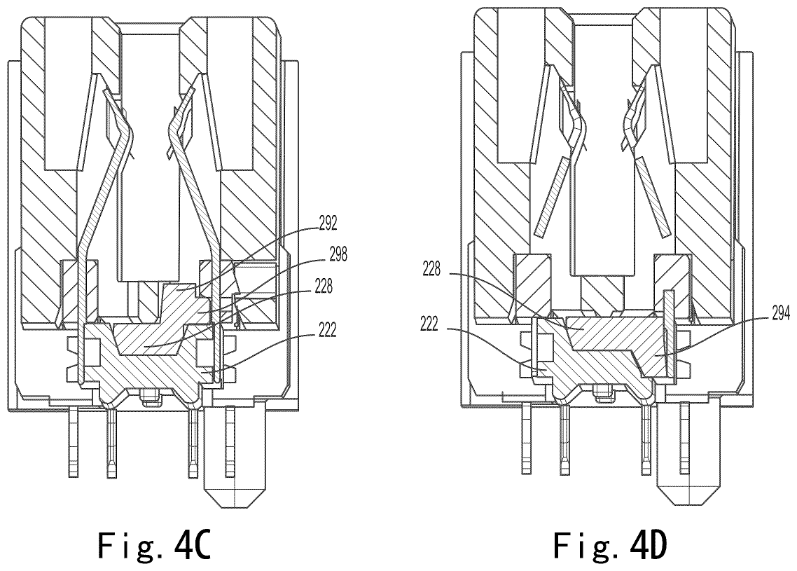

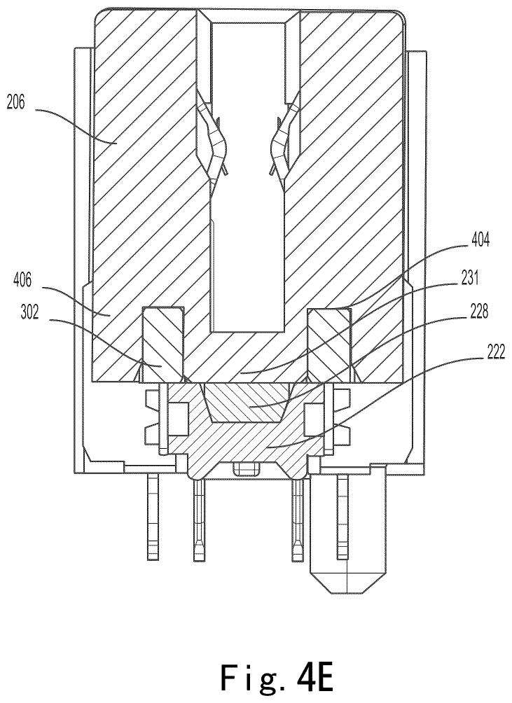

As illustrated in FIGS. 2A-2D, the connector 200 may include the housing 202, which may have a mating face 124 that PCB 104 may be inserted through. The housing 202 may include a first portion 204 and a second portion 206 separated from the first portion 204 by a rib 216. The first portion 204 may include a first slot 212 elongated in a longitudinal direction perpendicular to the mating direction 116, and first channels 208 at least partially divided by separators 233. Each first channel 208 may be configured for holding a power conductor 236 such that mating contact portions 244 of the power conductors 236 may curve into the first slot 212 for making contact with PCB 104 when it is inserted therein. Each separator 233 may include one or more slots 235 configured for wider portions 237 of the power conductors 236 to extend therein, which may ensure the power conductors 236 secured in respective channels 208. The first portion 204 may include a bar 276 adjacent the mating face 124 and configured to serve as a shelf for holding tip portions 248 of the power conductors 236 (see FIG. 4A).

The second portion 206 may include a second slot 214 elongated in the longitudinal direction, and second channels 210 at least partially divided by separators 231. Each second channel 210 may be configured for holding a signal conductor 238 or 240 such that mating contact portion 254 of the signal conductors 238 or 240 may curve into the second slot 214 for making contact with PCB 104 when it is inserted therein. The second portion 206 may include a bar 278 adjacent the mating face 124 and projections 218 extending from the bar 278 in the mating direction 116 such that the projections 218 may serve as a shelf for holding tip portions 258 of the signal conductors 238, 240 (see FIG. 4B). Such a configuration may enable the mating contact portions 254 of the signal conductors 238, 240 to be disposed lower in the mating direction 116 than the mating contact portions 244 of the power conductors 236, which may enable turning on and off the power before connecting the signals. The projections 218 may have surfaces 402 slanted toward the second slot 214 such that the signal conductors 238, 240 can have shorter tip portions 258, which may improve signal integrity.

The first portion 204 may have a mounting face 120 opposite the mating face 124. The first channels 208 may extend through the mating face 124 and the mounting face 120. The second portion 206 may have a mounting face 122 opposite the mating face 124 and disposed above the mounting face 120 of the first portion 204 in the mating direction 116. The second channels 210 may extend through the mating face 124 and the mounting face 122.

As illustrated in FIGS. 2D and 2E, the power conductors 236 held in the first portion 204 of the housing 202 may each include a mating end 242 comprising the mating contact portion 244 and tip portion 248, a tail end 246 extending beyond the mounting face 120 of the first portion 204, and an intermediate portion 248. The mating end 242 may have a same width in the longitudinal direction as the intermediate portion 248, which may provide larger contact area for carrying sufficient power to an add-in card (e.g., PCB 104). Each of the power conductors 236 may include a wider portion 237 adjacent the tail end 246.

The power conductors 236 may include first-type power conductors 236A and second-type power conductors 236B disposed alternatively. The intermediate portion 248 of each of the first-type power conductors 236A may have a portion 250 bending inwardly. Such a configuration may enable more power conductors to be held by the first portion 204 without requiring a larger footprint.

Although the power conductors 236 are illustrated as separated conductors, it should be appreciated that the power conductors in a row may be stamped from a same sheet of metal and joined at their intermediate portions. Accordingly, there may be one power conductor on each side of the first slot 212 instead of a few separated ones.

Referring back to FIG. 2C, the housing 202 may include a bottom member 222 and a lossy member 228, both of which may be attached to the second portion 206. The second portion 206 may have projections 230 extending from the mounting face 122. The bottom member 222 may have openings 234, and the lossy member 228 may have openings 232 stacked with respective openings 234 of the bottom member 222 such that each projection 230 of the second portion 206 can extend through an opening 232 of the lossy member 228 and an opening 234 of the bottom member 222.

As illustrated in FIGS. 2H-2G, the bottom member 222 may include a body 282, pillars 284 extending from the body 282 toward the second portion 206, and projections 286 extending from the pillars 284 outwardly. Some of the projections 286 may have recesses 290, which may be configured for receiving transitions regions 268 of first-type signal conductors 238.

The lossy member 228 may include a body 291, upper pillars 292 extending front the body 291 toward the second portion 206, lower pillars 294 extending from the body 291 away from the second portion 206 and configured to be disposed between pillars 284 of the bottom member 222. The upper pillars 292 may include projections 298 protruding outwardly. The lower pillars 294 may include recesses 296, which may be configured for receiving transition regions 268 of second-type signal conductors 240. As illustrated, each upper pillar 292 may have a corresponding lower pillar 294, which may be offset from the upper pillar 292 in the longitudinal direction according to the configuration of a respective second-type signal conductor 240.

As illustrated in FIG. 2F, the signal conductors 238, 240 held in the second portion 206 of the housing 202 may each include a mating end 252 comprising the mating contact portion 254 and tip portion 258, a tail end 256 extending beyond the mounting face 122 of the second portion 206, and an intermediate portion 260. The mating end 252 may have a width in the longitudinal direction less than that of the intermediate portion 260, which may increase separations between adjacent mating ends 252 and therefore reduce cross talk at the mating interface. Further, as shown in FIG. 2D, the mating end 252 of a signal conductor 238 or 240 may have a width in the longitudinal direction less than that of the mating end 242 of a power conductor 236. Such a configuration may enable the connector 200 for carrying sufficient power by the power conductors 236 and transmitting high-speed signals with high integrity by the signal conductors 238, 240.

The intermediate portion 260 of each of the signal conductors 238, 240 may include a transition region 268 such that the tail end 256 may be recessed from the intermediate portion 260. For each of the signal conductors 238, 240, the intermediate portion 260 may comprise a first surface 265 and a second surface 267 on opposite sides. The tail end 256 may comprise a third surface 269 and a fourth surface 271 on opposite sides. The third surface 269 of the tail end 256 may extend from the first surface 265 of the intermediate portion 260. The fourth surface 271 of the tail end 256 may be offset from the second surface 267 of the intermediate portion 260. Such a configuration may provide space for the projections 286 of the bottom member 222 or the lower pillars 294 of the lossy member 228 to protrude in and therefore provide mechanical support to the tail end 256. The resulting thinner tail end 256 may reduce the impedance impact of the added mass of a cable wire attached to the tail end 256 and therefore reduce impedance imbalance at the mounting interface.

The signal conductors 238, 240 may include first-type signal conductors 238 and second-type signal conductors 240. The first-type signal conductors 238 may be configured for transmitting high-speed signals or low-speed signals. The second-type signal conductors 240 may be configured for providing reference or return path for the signals. As illustrated in FIGS. 4B-4D, the tail ends 256 of the first-type signal conductors 238 may abut the projections 286 of the bottom member 222. The projections 286 of the bottom member 222 may be configured to provide support for and improve impedance imbalance at the cable attachments. The tail ends 256 of the second-type signal conductors 240 may abut the lower pillars 294 of the lossy member 228. Portions of the intermediate portions 260 of the second-type signal conductors 240 may abut the projections 298 of the upper pillars 292 of the lossy member 228. Such a configuration may provide support for the cable attachments and sufficiently couple the second-type signal conductors 240, which may improve signal integrity at higher speeds.

Referring back to FIG. 2F, the first-type signal conductors 238 and second-type signal conductors 240 may be arranged in groups 280. A group 280 may include one or more pairs of first-type signal conductors 238, each pair of which may be configured for transmitting a pair of differential signals. The intermediate portion 260 of each pair of the first-type signal conductors 238 may have surfaces 266 slanted toward each other so as to enhance coupling between each other.

A group 280 may include second-type signal conductors 240 disposed on opposite sides of each pair of first-type signal conductors 238. The intermediate portion 260 of each of the second-type signal conductors 240 may include a portion 262 bending toward an adjacent first-type signal conductor 238 such that the corresponding tail end 256 may be disposed closer to the adjacent first-type signal conductor 238 and therefore provide shielding. Some second-type signal conductors 240 may be shared by two pairs of the first-type signal conductors. The intermediate portion 260 of each of these second-type signal conductors 240 may include two portions 262 bending toward adjacent first-type signal conductors 238, respectively. The intermediate portion 260 of each of the second-type signal conductors 240 may include a projection 264 configured to make contact with the projection 298 of the upper pillar 292 of the lossy member 228.

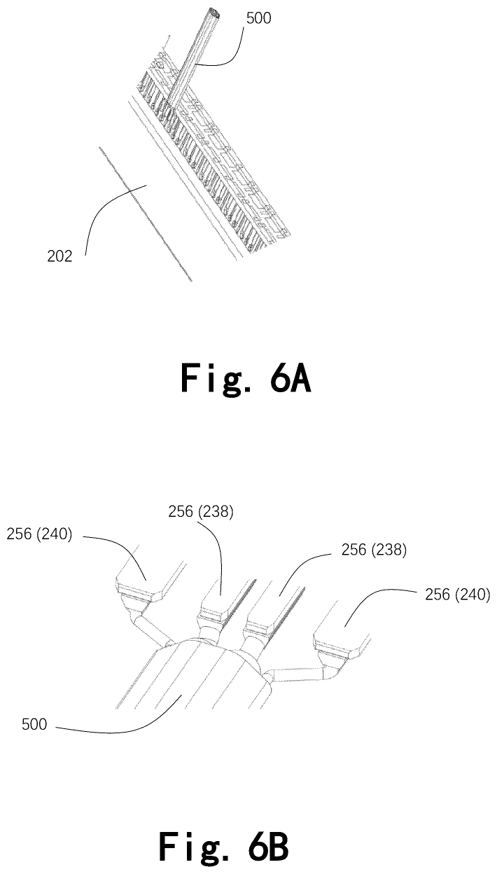

As illustrated, the mating ends 252 of the signal conductors 238, 240 in a group 280 may have a first center-to-center pitch p1 configured for mating with an electronic card (e.g., PCB 104), which may have contact pads uniformly spaced aligned along an edge. The tail ends of the signal conductors 238, 240 in a group 280 may have a second center-to-center pitch p2 configured for mounting with one cable 500, which may include a pair of signal wires and a pair of ground wires disposed on opposite sides of the pair of signal wires (see, e.g., FIGS. 6A and 6B). In some embodiments, the tail ends 256 of the second-type signal conductors 240 may be wider than the tail ends 256 of the first-type signal conductors 238, which may enhance shielding and therefore improve signal integrity. Accordingly, the second center-to-center pitch p2 between two first-type signal conductors 238 may be different from the second center-to-center pitch p2 between a first-type signal conductor 238 and a second-type signal conductor 240.

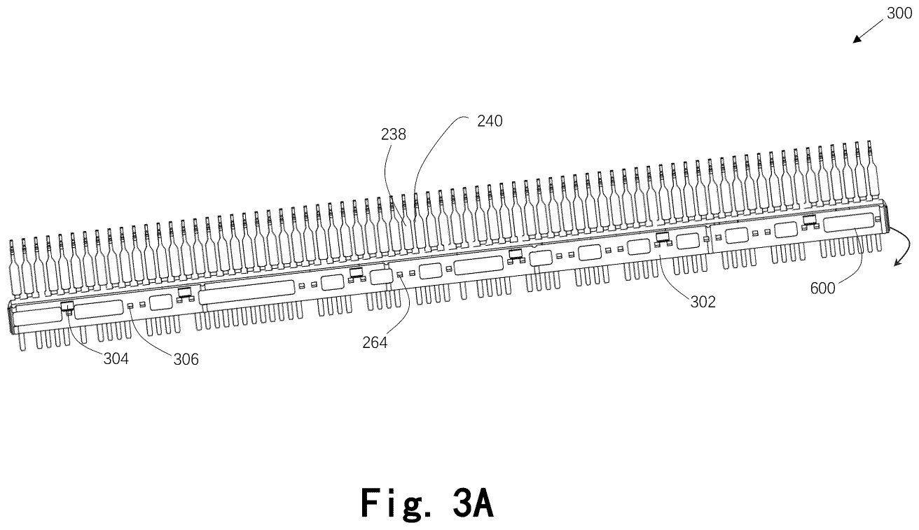

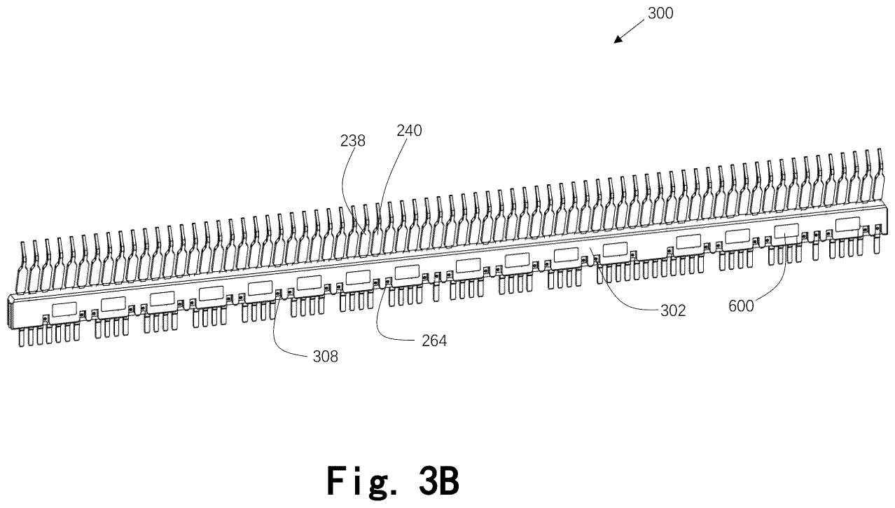

As shown in FIGS. 2D and FIGS. 3A-3B, the signal conductors 238, 240 in a row may be held by a subassembly housing 302, which may enable more precise spacing between the signal conductors 238, 240 and therefore reduce impedance imbalance along the lengths of the signal conductors 238, 240, improving signal integrity at higher speed. The subassembly housing 302 may include projections 304 configured to be disposed in matching openings of the housing 202 (see FIG. 4B). The subassembly housing 302 may include openings 306 and 308 disposed and sized corresponding to the projections 264 of the second-type signal conductors 240 such that the projections 264 may make contact with the projection 298 of the upper pillar 292 of the lossy member 228.

Referring to FIGS. 2C, 4E, the second portion 206 of the housing 202 may include spaces 404 between separators 231 and walls 406. The spaces 404 may be sized and shaped for holding respective subassembly housings 302. Such a configuration may ensure accurate positioning of the subassemblies 300 in the second portion 206 of the housing 202. Such a configuration may also ensure accurate relative positioning of the subassemblies 300 with respect to the bottom member 222 and the lossy member 228, for example, when combined with the matching projections 230 of the housing 202 and openings 232 of the lossy member 228 and openings 234 of the bottom member 222.

In some embodiments, the bottom member 222 and/or the lossy member 228 may be inserted into position after the subassemblies 300 are inserted. The bottom member 222 and/or the lossy member 228 described herein may provide support to the signal conductors 238, 240 so as to keep coplanarity among the signal conductors 238, 240 in each subassembly 300. The bottom member 222 and/or the lossy member 228 described herein may reduce the risks of distortion when cables are welded to the signal conductors 238, 240. The bottom member 222 and/or the lossy member 228 described herein may also block dust, moisture and other, solder flux of gas or other contaminants from entering the inside of the housing 202.

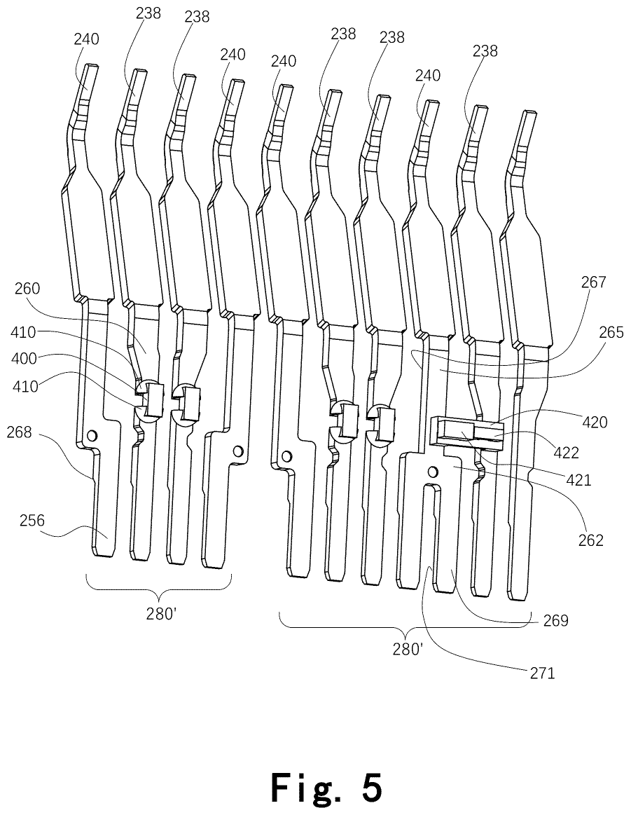

According to the present disclosure, as shown by FIG. 5, the first-type signal conductors 238 and the second-type signal conductors 240 can be arranged in a group 280′. Like the group 280, the group 280′ may include one or more pairs of first-type signal conductors 238, each pair of which may be configured for transmitting a pair of differential signals. Additionally, the group 280′ may also include a first-type signal conductor 238 for transmitting a sideband signal, for example two signal conductors on the left as shown by FIG. 5. The first-type signal conductors 238 for transmitting the sideband signal can be designed and configured in a manner similar to the first-type signal conductors 238 for transmitting the differential signal.

Different than the signal conductors 238, 240 of the group 280, a first-type signal conductor 238 of the group 280′ is configured such that when it acts as a signal conductor for transmitting a sideband signal, an intermediate portion 260 of the signal conductor 238 can be in advance longitudinally cut into and separated as a first segment and a second segment. For example, the cut location can be substantially at a position where the intermediate portion 260 of the signal conductor locates. Then, opposing free ends of the first and second cut segments of the signal conductor 238 can be connected to each other by an AC capacitor 400 respectively, for example by solder materials 410. In this way, in case that a cable 500 (as shown by FIGS. 6A and 6B) is connected to tail ends 256 of signal conductors 238, 240 of the group 280′, as the AC capacitor 400 has been embedded in the connector 200, a differential signal can be transmitted to a downstream electronic component by the cable 500 without an AC capacitor in the PCB. This facilitates in increasing signal transmission speed with avoiding unfavorable effects caused by resonance or cross talk. Moreover, the number of capacitors used in the PCB can be reduced such that the size of the PCB can be further reduced or more spaces can be left in the PCB for accommodating more other electronic components.

As shown by FIG. 5, in another group 280′, besides for a first-type signal conductor 238 for transmitting a differential signal, a first-type signal conductor 238 for transmitting a sideband signal (for example, the second first-type signal conductor from the right as shown) is provided. A first-type signal conductor 238 for transmitting a sideband signal may be referred to as a third-type signal conductor. A Resistance-Capacitance (RC) circuit block 420 can be provided between the first-type signal conductor 238 for transmitting the sideband signal and a second-type signal conductor 240 (for example, a second-type signal conductor 240 adjacent to the first-type signal conductor in the shown embodiment) to connect them together at the area where their intermediate portions 260 locate. For instance, the RC circuit block 420 comprises an AC capacitor 421 and a resistor 422 in series connected with each other.

In one or more rows of signal conductors 238, 240 of the connector 200, a different number of groups 280 and/or 280′ can be provided or defined. Moreover, each group 280′ can be also provided only with a first-type signal conductor 238 embedded with an AC capacitor 420 for transmitting a differential signal and a second-type signal conductor 240, or only with a first-type signal conductor 238 for transmitting a sideband signal and a second-type signal conductor 240 between which an RC circuit block 420 is embedded, or with both of a first-type signal conductor 238 embedded with an AC capacitor 420 for transmitting a differential signal and a first-type signal conductor 238 for transmitting a sideband signal and a second-type signal conductor 240 between which an RC circuit block 420 is embedded.

In the embodiment as shown by FIG. 5, the AC capacitor 400 and the RC circuit block 420 can be located on the first surfaces 265 of the intermediate portions 260 of the signal conductors 238, 240 respectively. In an alternative embodiment, the AC capacitor 400 and the RC circuit block 420 can be located on the second surfaces 267 of the intermediate portions 260 of the signal conductors 238, 240 respectively. In another alternative embodiment, the AC capacitor 400 and the RC circuit block 420 can be located on opposite surfaces of the intermediate portions 260 of the signal conductors 238, 240 respectively.

In FIG. 2D, two rows of signal conductors 238, 240 are shown to be held by two subassembly housings 302, wherein a group 280′ is provided or defined in the row of signal conductors 238, 240 in one of the subassembly housings 302, and no group 280 is provided or defined in the row of signal conductors 238, 240 in the other of the subassembly housings 302. The subassembly housing 302 as shown by FIGS. 3A and 3B can correspond to the subassembly housing 302 in which there is the group 280′ of signal conductors 238, 240.

As shown by FIGS. 3A and 3B, the subassembly housing 302 comprises a plurality of enclosing regions 600 distributed longitudinally. The signal conductors 238, 240 located in the respective enclosing regions 600 can be considered to constitute the respective groups 280′. An insulation enclosing material is provided in the respective enclosing regions 600 such that the outer surface of the subassembly housing 302 is flush with or slightly indent relative to outer surfaces of the enclosing regions 600, to prevent affecting fitting and assembling of the subassembly 310 or its subassembly housing 302 carried with the signal conductors 238, 240 in the housing 202. Although the AC capacitor 400 and the RC circuit block 420 have been embedded in the respective signal conductors 238, 240 and have been enclosed together with the subassembly housing 302, the positioning relation of the subassembly 302 or its constituent part including the group 280 of the signal conductors 238, 240 relative to the other constituent parts of the connector 200 in those contents described with regard to FIGS. 4B to 4E may also be applied to the positioning relation of a constituent part of the subassembly housing 302 including the group 280′ of signal conductors 238, 240 relative to the other constituent parts of the connector 200.

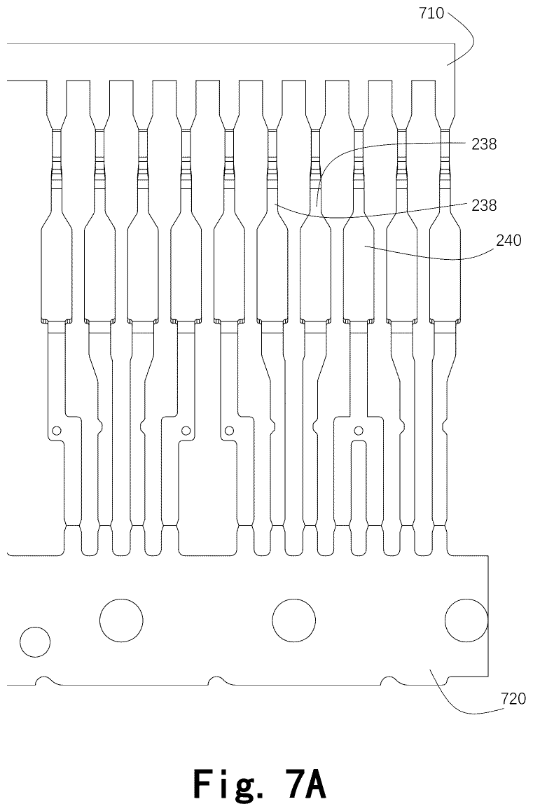

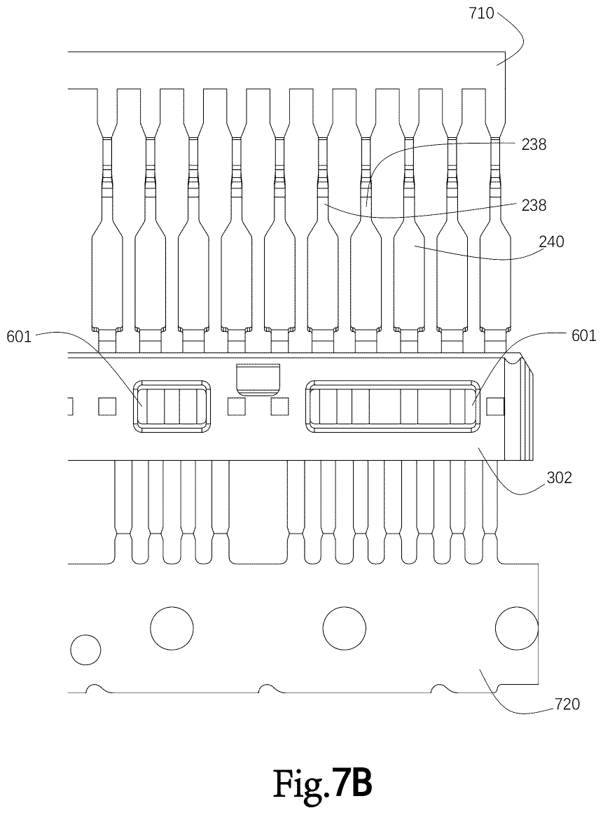

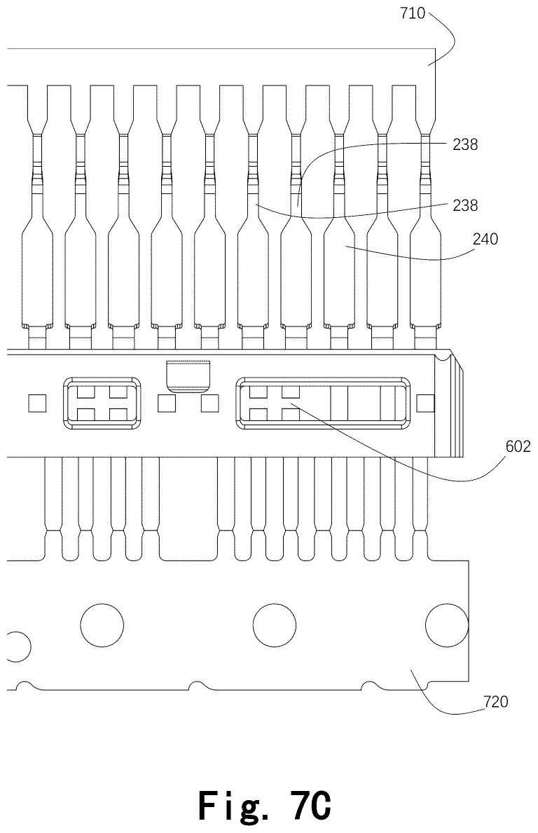

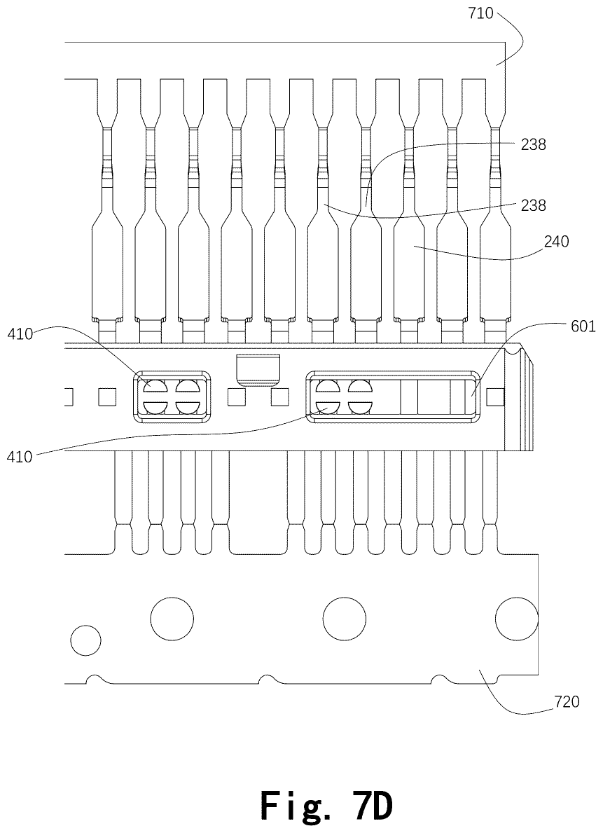

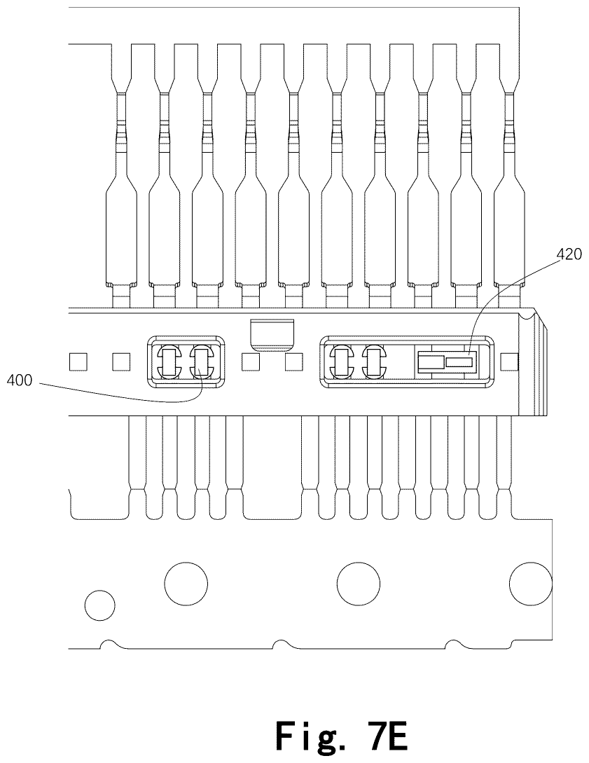

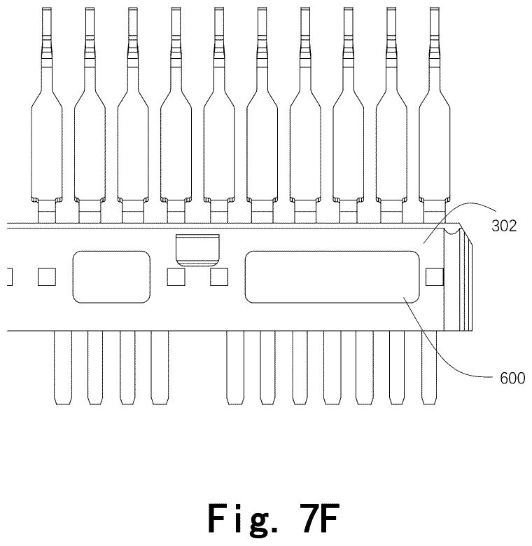

An example of a method for manufacturing a group 280′ of signal conductors 238, 240 according to the present disclosure will be illustratively explained with respect to FIGS. 7A to 7F below.

In FIG. 7A, a metallic sheet is stamped to form signal conductors 238, 240 therein. These signal conductors 238, 240 are arranged as required in a group 280′ and are connected to each other by respective weaken-connected stripes 710, 720 of the same metal respectively at opposite ends of the signal conductors. For example, these trips 710, 720 can be used to temporarily connect the signal conductors 238, 240, and can be readily separated from the signal conductors by bending the stripes after a corresponding subassembly 300 has been completely manufactured. As shown, a suitable casting mold can be used substantially at the intermediate portions 260 of the signal conductors 238, 240 to form a subassembly housing 302 there in a partial over-molded manner, and in the meanwhile, an aperture 601 is left at a location corresponding to each enclosing region 600.

In FIG. 7B, the aperture 601 is shown in the formed subassembly housing 302. For example, in the illustrated embodiment, the aperture 601 is formed to extend through the subassembly housing 302 in its thickness direction; and in the meanwhile, opposite surfaces of a first-type signal conductor 238 for transmitting a differential signal and/or of a first-type signal conductor 238 for transmitting a sideband signal can be enabled to be exposed in the aperture 601.

In order to cut and separate the first-type signal conductor 238 for transmitting the differential signal into and from a first segment and a second segment respectively, a hard block can be arranged in the aperture 601 at a surface of a respective signal conductor 238 and then it is stamped from an opposite surface of the signal conductor 230 to form a break 602 as shown by FIG. 7C. For example, measured in a longitudinal direction of the signal conductor, the break 602 has an opening distance of about 0.25 millimeter (mm). In an embodiment of the present disclosure, the opening distance of the break 602 can depend on the size of an AC capacitor (for example, a distance between two electrodes of the AC capacitor). After the break 602 is formed, the hard block can be removed.

In an alternative embodiment, a first-type signal conductor 238 for transmitting a differential signal can be stamped with a similar break 602 before the subassembly housing 302 is over-molded. In this case, the correspondingly stamped first-type conductor 238 in the row of signal conductors 238, 240 can be temporarily secured by the stripes 710, 720. In this case, it is not necessary to form the aperture 601 to extend through the subassembly housing 302 in its longitudinal direction. Rather, the aperture 601 can be formed such that the surfaces of the signal conductors 238, 240 on which an AC capacitor or an RC circuit block is to be attached can be exposed.

As shown by FIG. 7D, solder materials 410 can be respectively disposed at free ends of the first and second segments of the first-type signal conductor 238 for transmitting the differential signal. Bonding pads 410 can be respectively disposed at free ends of the first-type signal conductor for transmitting the sideband signal and an adjacent second-type signal conductor 240.

Then, as shown by FIG. 7E, an AC capacitor 400 can be arranged at the solder materials 238 of the first-type signal conductor 238 for transmitting the differential signal and an RC circuit block 420, which is provided with an AC capacitor 421 and a resistor 422 in series connected with each other, can be arranged at the first-type signal conductor 238 for transmitting the sideband signal and an adjacent second-type signal conductor 240, and the AC capacitor 400 and the RC circuit block 420 can be attached and thus secured using a reflow process.

Finally, as shown by FIG. 7E, an insulation enclosing material such as an ultraviolet-curable adhesive can be used to fill and enclose the break 602 from a side thereof (for example both sides thereof) such that the outer surfaces of the respective enclosing region 600 can be flush with or slightly indent relative to the respective surrounding surfaces of the subassembly housing 302. In this way, respective signal conductors 238, 240 in the group 280′ can be connected directly to a cable 500 by a laser welding process, to save the wiring space in a respective PCB and simplify the wiring difficulty in the PCB with avoiding negative effects caused by resonance or cross talk in a circuit.

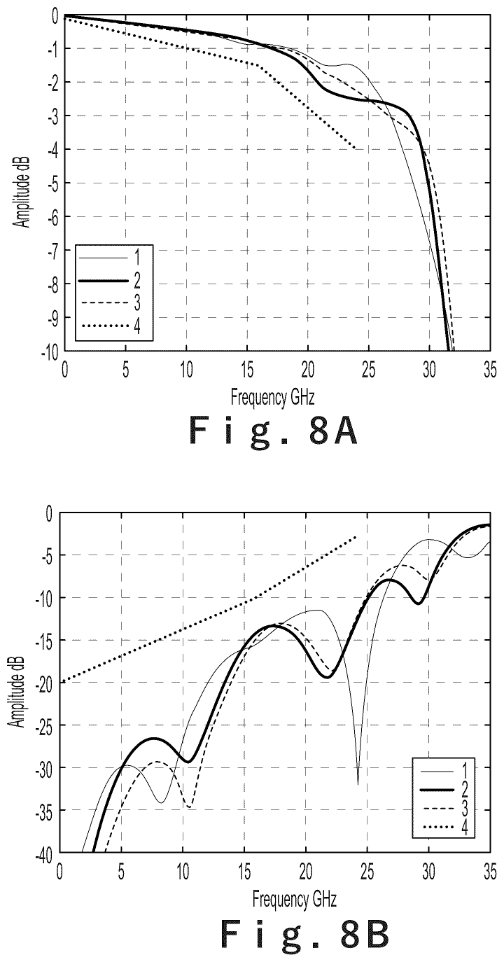

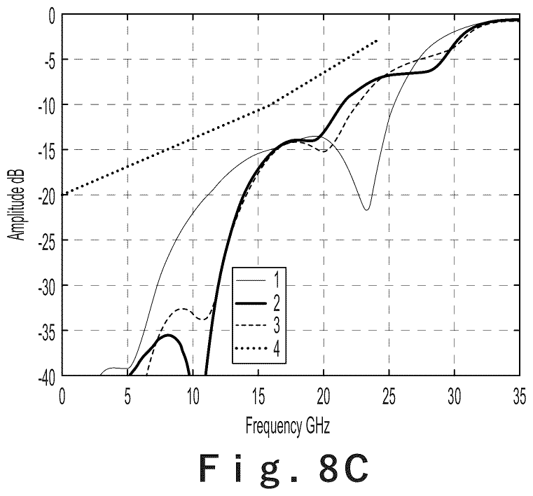

A software named as Intel Passive Component Checker is used to carry out a signal integrity simulation test for the connector 200 as shown and a conventional connector having the same specification, to obtain frequency attenuation curves of differential insertion loss, differential return loss (cable side), and differential return loss (card side) of signal conductors, as shown by FIGS. 8A to 8C. In FIGS. 8A to 8C, a curve 1 represents a frequency attenuation curve of a conventional direct-cable-connection-type connector, a curve 2 represents a frequency attenuation curve of a subassembly of a direct-cable-connection-type connector according to the present disclosure in which a signal conductor for transmitting a differential signal is embedded with an AC capacitor, a curve 3 represents a frequency attenuation curve of a subassembly of a direct-cable-connection-type connector according to the present disclosure in which no signal conductor for transmitting a differential signal is embedded with an AC capacitor, and a curve 4 represents a frequency attenuation curve based on PCIe Standards. By comparison between those curves, especially in a higher frequency range (for example the frequency being over 16 GHZ), the frequency attenuation characteristic of the subassembly of the direct-cable-connection-type connector according to the present disclosure embedded with the AC capacitor is greatly advantageous over that of the conventional direct-cable-connection-type connector in which no AC capacitor is embedded, and is closer to that of the PCIe Standards.

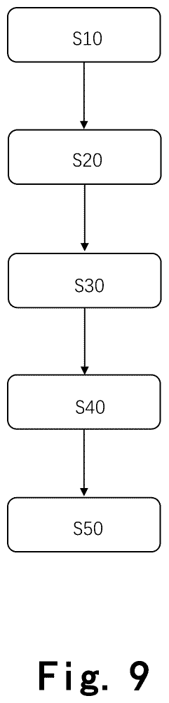

FIG. 9 schematically illustrates a flow chart of an example of a method for assembling a connector 200. First, at step S10, a housing 202 of the connector 200 is provided. At step S20, power conductors 236 (first-type power conductors 236A and second-type power conductors 236B) can be fitted into a first portion 204 of the housing 202. At step S30, two rows of signal conductors 238, 240 can be respectively fitted into a second portion 206 of the housing 202, wherein the two rows of signal conductors 238, 240 can include one or more groups 280, 280′. At step S40, a lossy member 228 and a bottom member 222 can be fitted into the housing 202. Finally, at step S50, a board lock 226 can be inserted and secured in the housing 202 in place to achieve the overall assembly of the connector 200.

In some embodiments, housing components, such as the housing 202 and bottom member 222, may be dielectric members molded from a dielectric material such as plastic or nylon. Examples of suitable materials include, but are not limited to, liquid crystal polymer (LCP), polyphenylene sulfide (PPS), high temperature nylon or polyphenylenoxide (PPO) or polypropylene (PP). Other suitable materials may be employed, as aspects of the present disclosure are not limited in this regard.

In some embodiments, conductive elements such as power conductors 236 and signal conductors 238, 240 may be made of metal or any other material that is conductive and provides suitable mechanical properties for conductive elements in an electrical connector. Phosphor-bronze, beryllium copper and other copper alloys are non-limiting examples of materials that may be used. The conductive elements may be formed from such materials in any suitable way, including by stamping and/or forming.

In some embodiments, lossy members such as lossy member 228 may be made of materials that dissipate a sufficient portion of the electromagnetic energy interacting with that material to appreciably impact the performance of a connector may be regarded as lossy. A meaningful impact results from attenuation over a frequency range of interest for a connector. In some configurations, lossy material may suppress resonances within ground structures of the connector and the frequency range of interest may include the natural frequency of the resonant structure, without the lossy material in place. In other configurations, the frequency range of interest may be all or part of the operating frequency range of the connector.

For testing whether a material is lossy, the material may be tested over a frequency range that may be smaller than or different from the frequency range of interest of the connector in which the material is used. For example, the test frequency range may extend from 10 GHz to 25 GHz or 1 GHz to 5 GHz. Alternatively, lossy material may be identified from measurements made at a single frequency, such as 10 GHz or 15 GHZ.

Loss may result from interaction of an electric field component of electromagnetic energy with the material, in which case the material may be termed electrically lossy. Alternatively or additionally, loss may result from interaction of a magnetic field component of the electromagnetic energy with the material, in which case the material may be termed magnetically lossy.

Electrically lossy materials can be formed from lossy dielectric and/or poorly conductive materials. Electrically lossy material can be formed from material traditionally regarded as dielectric materials, such as those that have an electric loss tangent greater than approximately 0.01, greater than 0.05, or between 0.01 and 0.2 in the frequency range of interest. The “electric loss tangent” is the ratio of the imaginary part to the real part of the complex electrical permittivity of the material.

Electrically lossy materials can also be formed from materials that are generally thought of as conductors, but are relatively poor conductors over the frequency range of interest. These materials may conduct, but with some loss, over the frequency range of interest such that the material conducts more poorly than a conductor of an electrical connector, but better than an insulator used in the connector. Such materials may contain conductive particles or regions that are sufficiently dispersed that they do not provide high conductivity or otherwise are prepared with properties that lead to a relatively weak bulk conductivity compared to a good conductor such as pure copper over the frequency range of interest. Die cast metals or poorly conductive metal alloys, for example, may provide sufficient loss in some configurations.

Electrically lossy materials of this type typically have a bulk conductivity of about 1 Siemen/meter to about 100,000 Siemens/meter, or about 1 Siemen/meter to about 30,000 Siemens/meter, or 1 Siemen/meter to about 10,000 Siemens/meter. In some embodiments, material with a bulk conductivity of between about 1 Siemens/meter and about 500 Siemens/meter may be used. As a specific example, material with a conductivity between about 50 Siemens/meter and 300 Siemens/meter may be used. However, it should be appreciated that the conductivity of the material may be selected empirically or through electrical simulation using known simulation tools to determine a conductivity that provides suitable signal integrity (SI) characteristics in a connector. The measured or simulated SI characteristics may be, for example, low cross talk in combination with a low signal path attenuation or insertion loss, or a low insertion loss deviation as a function of frequency.

It should also be appreciated that a lossy member need not have uniform properties over its entire volume. A lossy member, for example, may have an insulative skin or a conductive core, for example. A member may be identified as lossy if its properties on average in the regions that interact with electromagnetic energy sufficiently attenuate the electromagnetic energy.

In some embodiments, lossy material is formed by adding to a binder a filler that contains particles. In such an embodiment, a lossy member may be formed by molding or otherwise shaping the binder with filler into a desired form. The lossy material may be molded over and/or through openings in conductors, which may be ground conductors or shields of the connector. Molding lossy material over or through openings in a conductor may ensure intimate contact between the lossy material and the conductor, which may reduce the possibility that the conductor will support a resonance at a frequency of interest. This intimate contact may, but need not, result in an Ohmic contact between the lossy material and the conductor.

Alternatively or additionally, the lossy material may be molded over or injected into insulative material, or vice versa, such as in a two shot molding operation. The lossy material may press against or be positioned sufficiently near a ground conductor that there is appreciable coupling to a ground conductor. Intimate contact is not a requirement for electrical coupling between lossy material and a conductor, as sufficient electrical coupling, such as capacitive coupling, between a lossy member and a conductor may yield the desired result. For example, in some scenarios, 100 pF of coupling between a lossy member and a ground conductor may provide an appreciable impact on the suppression of resonance in the ground conductor. In other examples with frequencies in the range of approximately 10 GHz or higher, a reduction in the amount of electromagnetic energy in a conductor may be provided by sufficient capacitive coupling between a lossy material and the conductor with a mutual capacitance of at least about 0.005 pF, such as in a range between about 0.01 pF to about 100 pF, between about 0.01 pF to about 10 pF, or between about 0.01 pF to about 1 pF. To determine whether lossy material is coupled to a conductor, coupling may be measured at a test frequency, such as 15 GHz or over a test range, such as 10 GHz to 25 GHZ.

To form an electrically lossy material, the filler may be conductive particles. Examples of conductive particles that may be used as a filler to form an electrically lossy material include carbon or graphite formed as fibers, flakes, nanoparticles, or other types of particles. Various forms of fiber, in woven or non-woven form, coated or non-coated may be used. Non-woven carbon fiber is one suitable material. Metal in the form of powder, flakes, fibers or other particles may also be used to provide suitable electrically lossy properties. Alternatively, combinations of fillers may be used. For example, metal plated carbon particles may be used. Silver and nickel are suitable metal plating for fibers. Coated particles may be used alone or in combination with other fillers, such as carbon flake.

Preferably, the fillers will be present in a sufficient volume percentage to allow conducting paths to be created from particle to particle. For example, when metal fiber is used, the fiber may be present in about 3% to 30% by volume. The amount of filler may impact the conducting properties of the material, and the volume percentage of filler may be lower in this range to provide sufficient loss.

The binder or matrix may be any material that will set, cure, or can otherwise be used to position the filler material. In some embodiments, the binder may be a thermoplastic material traditionally used in the manufacture of electrical connectors to facilitate the molding of the electrically lossy material into the desired shapes and locations as part of the manufacture of the electrical connector. Examples of such materials include liquid crystal polymer (LCP) and nylon. However, many alternative forms of binder materials may be used. Curable materials, such as epoxies, may serve as a binder. Alternatively, materials such as thermosetting resins or adhesives may be used.

While the above-described binder materials may be used to create an electrically lossy material by forming a binder around conducting particle fillers, lossy materials may be formed with other binders or in other ways. In some examples, conducting particles may be impregnated into a formed matrix material or may be coated onto a formed matrix material, such as by applying a conductive coating to a plastic component or a metal component. As used herein, the term “binder” encompasses a material that encapsulates the filler, is impregnated with the filler or otherwise serves as a substrate to hold the filler.

Magnetically lossy material can be formed, for example, from materials traditionally regarded as ferromagnetic materials, such as those that have a magnetic loss tangent greater than approximately 0.05 in the frequency range of interest. The “magnetic loss tangent” is the ratio of the imaginary part to the real part of the complex electrical permeability of the material. Materials with higher loss tangents may also be used.

In some embodiments, a magnetically lossy material may be formed of a binder or matrix material filled with particles that provide that layer with magnetically lossy characteristics. The magnetically lossy particles may be in any convenient form, such as flakes or fibers. Ferrites are common magnetically lossy materials. Materials such as magnesium ferrite, nickel ferrite, lithium ferrite, yttrium garnet or aluminum garnet may be used. Ferrites will generally have a loss tangent above 0.1 at the frequency range of interest. Presently preferred ferrite materials have a loss tangent between approximately 0.1 and 1.0 over the frequency range of 1 GHz to 3 GHz and more preferably a magnetic loss tangent above 0.5 over that frequency range.

Practical magnetically lossy materials or mixtures containing magnetically lossy materials may also exhibit useful amounts of dielectric loss or conductive loss effects over portions of the frequency range of interest. Suitable materials may be formed by adding fillers that produce magnetic loss to a binder, similar to the way that electrically lossy materials may be formed, as described above.

It is possible that a material may simultaneously be a lossy dielectric or a lossy conductor and a magnetically lossy material. Such materials may be formed, for example, by using magnetically lossy fillers that are partially conductive or by using a combination of magnetically lossy and electrically lossy fillers.

Lossy portions also may be formed in a number of ways. In some examples the binder material, with fillers, may be molded into a desired shape and then set in that shape. In other examples the binder material may be formed into a sheet or other shape, from which a lossy member of a desired shape may be cut. In some embodiments, a lossy portion may be formed by interleaving layers of lossy and conductive material such as metal foil. These layers may be rigidly attached to one another, such as through the use of epoxy or other adhesive, or may be held together in any other suitable way. The layers may be of the desired shape before being secured to one another or may be stamped or otherwise shaped after they are held together. As a further alternative, lossy portions may be formed by plating plastic or other insulative material with a lossy coating, such as a diffuse metal coating.

Although details of specific configurations of conductive elements and housings are described above, it should be appreciated that such details are provided solely for purposes of illustration, as the concepts disclosed herein are capable of other manners of implementation. In that respect, various connector designs described herein may be used in any suitable combination, as aspects of the present disclosure are not limited to the particular combinations shown in the drawings.

Having thus described several embodiments, it is to be appreciated various alterations, modifications, and improvements may readily occur to those skilled in the art.

For example, techniques as described herein may be embodied in card edge connectors or connectors configured only for high-speed signals.

As another example, high-speed and low-speed signal conductors may be configured the same, with signal conductors in the same row having the same shape. The high-speed and low-speed signal conductors nonetheless may be differentiated based on the ground structures and insulative portions around them. Alternatively, some or all of the high-speed signal conductors may be configured differently from low-speed signal conductors, even within the same row. The edge-to-edge spacing may be closer for high-speed signal conductors, for example.

Connectors are illustrated that have mating locations and mounting locations that may be compatible with a PCIe standard. Techniques as described herein may be used to increase the operating speed of connectors designed according to other standards.

As another example, exemplary connectors were illustrated in which an entire row of signal conductors was formed as a subassembly. Other examples may have multiple subassemblies per row.

Such alterations, modifications, and improvements are intended to be within the spirit and scope of the invention. Accordingly, the foregoing description and drawings are by way of example only.

Furthermore, techniques for increasing the operating speed of a connector, even when constrained by dimensions specified in an industry standard, are shown and described with reference to a card edge connector, it should be appreciated that aspects of the present disclosure are not limited in this regard, as any of the inventive concepts, whether alone or in combination with one or more other inventive concepts, may be used in other types of electrical connectors, such as receptacle connectors, backplane connectors, right angle connectors, stacking connectors, mezzanine connectors, I/O connectors, chip sockets, etc.

In some embodiments, tail ends were illustrated as press fit “eye of the needle” that are designed to insert into printed circuit boards. However, other configurations may also be used, such as surface mount contacts, spring contacts, solderable pins, etc.

All definitions, as defined and used, should be understood to control over dictionary definitions, definitions in documents incorporated by reference, and/or ordinary meanings of the defined terms.

Numerical values and ranges may be described in the specification and claims as approximate or exact values or ranges. For example, in some cases the terms “about,” “approximately,” and “substantially” may be used in reference to a value. Such references are intended to encompass the referenced value as well as plus and minus reasonable variations of the value.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

In the claims, as well as in the specification above, use of ordinal terms such as “first,” “second,” “third,” etc. does not by itself connote any priority, precedence, or order of one element over another or the temporal order in which acts of a method are performed, but are used merely as labels to distinguish one element having a certain name from another element having a same name (but for use of the ordinal term) to distinguish the elements.

Although some specific embodiments of the present disclosure have been described here, they are given for illustrative purposes only and cannot be deemed to constrain the scope of the present disclosure in any way. Further, it should be understood by a person skilled in the art that various embodiments described here can be arbitrarily combined with each other. Without departing from the spirit and scope of the present disclosure, various alternations, replacements and modifications can be thought out.

What is claimed is:

1. A connector subassembly for a connector configured for direct attachment to a cable, comprising:
a subassembly housing comprising a first side, a second side opposite the first side, and at least one aperture;
a plurality of conductive elements held by the subassembly housing in a row, each of the plurality of conductive elements comprising a mating end extending out of the first side of the subassembly housing, and a tail end extending out of the second side of the subassembly housing and configured for direct attachment to a conductor of a cable, the plurality of conductive elements comprising:
a first subset, each conductive element in the first subset comprising an intermediate portion exposed in an aperture of the least one aperture, and
a second subset; and
a plurality of capacitors, each of the plurality of capacitors electrically coupled to a conductive element in the first subset within an aperture of the at least one aperture.

2. The connector subassembly of claim 1, wherein:
the intermediate portion of each conductive element in the first subset comprises a break; and
each of the plurality of capacitors is disposed at the break of the intermediate portion of a respective conductive element in the first subset so as to couple the mating end and tail end of the respective conductive element in the first subset.

3. The connector subassembly of claim 1, comprising:
a plurality of circuit blocks each connecting two adjacent conductive elements in the first subset, each of the plurality of circuit blocks comprising a respective capacitor of the plurality of capacitors.

4. A connector configured for mounting to a circuit board, the connector comprising:
a subassembly housing comprising a first side and a second side opposite the first side;
a plurality of conductive elements held by the subassembly housing in a row, each of the plurality of conductive elements comprising a mating end extending out of a first side of the subassembly housing, and a tail end extending out of the second side of the subassembly housing and configured for direct attachment to a cable that passes through the circuit board, the plurality of conductive elements comprising:
a plurality of first-type conductors each comprising an intermediate portion between the respective mating end and tail end, the intermediate portion having a break, and
a plurality of second-type conductors each comprising an intermediate portion between the respective mating end and tail end; and
a plurality of capacitors each disposed at the break of the intermediate portion of a respective first-type conductor of the plurality of first-type conductors so as to couple the mating end and tail end of the respective first-type conductor.

5. The connector of claim 4, wherein:
the subassembly housing comprises a plurality of apertures;
the breaks of the plurality of first-type conductors are disposed in respective apertures of the plurality of apertures of the subassembly housing; and
the connector subassembly comprises an insulative material disposed in the plurality of apertures of the subassembly housing.

6. The connector of claim 5, wherein:
the insulative material is cured adhesive.

7. The connector of claim 4, wherein:
each of the plurality of first-type conductors comprises a first segment and a second segment separated by the break; and
for each of the plurality of first-type conductors, the connector subassembly comprises:
a first solder material joining the first segment and a first end of a respective capacitor, and
a second solder material joining the second segment and a second end of the respective capacitor.

8. The connector of claim 4, wherein:
the plurality of first-type conductors are disposed in pairs between second-type conductors of the plurality of second-type conductors.

9. The connector of claim 8, further comprising:
a plurality of cables each comprising:
a pair of signal wires attached to a respective pair of first-type conductors, and
a reference wire attached to a second-type conductor adjacent the respective pair of first-type conductors.

10. The connector of claim 8, further comprising:
a third-type conductor disposed adjacent to a second-type conductor of the plurality of second-type conductors; and
a circuit block comprising a first end disposed on the second-type conductor adjacent the third-type conductor and a second end disposed on the third-type conductors, the circuit block comprising a capacitor and a resistor connected in series.

11. The connector of claim 10, wherein:
an end of the capacitor of the circuit block is disposed on the second-type conductor; and
an end of the resistor of the circuit block is disposed on the third-type conductor.

12. The connector of claim 10, wherein:
the third-type conductor is shaped similar to a first-type conductor of the plurality of first-type conductors;
the second-type conductor comprises a first tail end and a second tail end;
the first tail end is disposed closer to a first-type conductor of the plurality of first-type conductors than the third-type conductor; and
the second tail end is disposed between the first tail end and the third-type conductor.

13. The connector of claim 8, wherein, for each of the plurality of second-type conductors:
the second-type conductor comprises a portion jogging toward an adjacent first-type conductor; and
the capacitor disposed on the adjacent first-type conductor is disposed offset from the portion of the second-type conductor.

14. An electronic system comprising:
a circuit board comprising an opening; and
an electrical connector comprising:
a housing at least partially mounted to the circuit board and comprising a first face with a first slot and a second face facing the circuit board;
a plurality of capacitors disposed in the housing; and
a plurality of first-type conductors disposed in a row in the housing, each of the plurality of first-type conductors comprising a first segment having a mating end curving into the first slot, and a second segment having a tail end extending out of the housing to the opening of the circuit board, the second segment coupled to the first segment by a respective capacitor of the plurality of capacitors.

15. The electronic system of claim 14, wherein:
the plurality of capacitors are aligned in a line.

16. The electronic system of claim 14, wherein the electrical connector comprises:
a plurality of second-type conductors disposed in the housing and aligned in the row of first-type conductors, each of the plurality of second-type conductors comprising:
a mating end curving into the first slot and having a first center-to-center pitch to the mating end of an adjacent first-type conductor,
a tail end extending out of the housing and having a second center-to-center pitch to the tail end of the adjacent first-type conductor, the second center-to-center pitch less than the first center-to-center pitch, and
an intermediate portion joining the mating end and the first tail end.

17. The electronic system of claim 16, wherein the electrical connector comprises:
a third-type conductor disposed adjacent to a second-type conductor of the plurality of second-type conductors; and
a circuit block comprising a first end disposed on the second-type conductor adjacent the third-type conductor and a second end disposed on the third-type conductors, the circuit block comprising a capacitor and a resistor connected in series.

18. The electronic system of claim 17, wherein:
the circuit block is aligned with the plurality of capacitors.

19. The electronic system of claim 16, wherein the electrical connector comprises:
a bottom member attached to the housing, the bottom member comprising:
a body,
a plurality of pillars extending from the body toward the housing, and
a plurality of projections extending from the pillars and toward tail ends of the plurality of first-type conductors.

20. The electronic system of claim 19, wherein the electrical connector comprises:
a lossy member attached to the bottom member and configured to electrically couple the plurality of second-type conductors.

21. The electronic system of claim 16, wherein:
the tail ends of the first-type and second-type conductors are configured for cables to be attached thereon;
the housing comprises a second slot separated from the first slot by a rib; and
the electrical connector comprises a plurality of fourth-type conductors, each of the plurality of fourth-type conductors comprising a mating end curving into the second slot, a tail end extending out of the housing and mounted to the circuit board.
